(19) United States
(12) Patent Application Publication
(10) Pub. No.: US 2006/0092149 A1
(43) Pub. Date: May 4, 2006

(54) Data driver, electro-optic device, electronic instrument and driving method

(75) Inventor: Akira Morita, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/262,345

(22) Filed: Oct. 28, 2005

(30) Foreign Application Priority Data
Oct. 29, 2004 (JP) 2004-316021

(51) Int. Cl. G09G 5/00

(52) U.S. Cl. 345/204

(57) ABSTRACT

A data driver drives each data line of a plurality of data lines of an electro-optic device based on display data of (i+j) bits (i and j are natural numbers), and the data driver includes: a memory which previously holds data of j-bit among the display data as retained data; and a driving section which drives the data line based on the display data. The driving section drives the data line based on the display data of (i+j) bits, the display data of (i+j) bits being generated by input data of i bits supplied to the data driver, and the retained data read out from the memory.

Japanese Patent Application No. 2004-316021, filed on Oct. 29, 2004, is hereby incorporated by reference in its entirety.

### BACKGROUND OF THE INVENTION

The present invention relates to a data driver, an electro-optic device, an electronic instrument and a driving method.

Electro-optic devices, typically liquid crystal display panels, are commonly employed as a display unit of mobile electronic instruments, such as mobile phones or the like, in order to attain low power consumption. Drivers driving such electro-optic devices can further achieve the low power consumption, by having built-in memories that store display data corresponding to display images. On the other hand, the chip size of the driver grows larger due to the built-in memory, resulting in the increase of production cost. Therefore, those drivers have built-in memories with a minimum capacity corresponding to the screen size of the electro-optic device, in order to lower the power consumption, while suppressing the increase of the production cost as much as possible.

The capacity of the memory built in the driver is determined, not only by the screen size of the electro-optic device, but also by the number of colors of the display image. If the capacity of the memory needs to be decreased, it is necessary to decrease the gradation number (number of colors) per one dot of the display data.

However, there is a strong requirement for the electro-optic devices of recent years, that the drivers driving the electro-optic devices suppress the capacity of the built-in memory to a minimum, and yet achieve a multicolor gradational expression.

The above-mentioned driver may be installed, for instance, with an error diffusion processing controller, may perform a color reduction processing of display data for an original image with this error diffusion processing controller, and may hold the display data after performing the color reduction processing to the memory built-in to the driver. By performing the color reduction processing, the gradation can be distributed in space; therefore, compared to the case of simply cutting down the low bits of the display data, it is possible to express an image where the borderline is inconspicuous. Additionally, since the capacity of the display data after the color reduction processing can be made smaller than that of the original image, it is possible to lower the power consumption as well as to lower the cost, without causing the image quality to deteriorate much.

This technology is described, for instance, in JP-A-2002-251173.

The common driver involves a problem of not being able to avoid the image quality deterioration, when comparing the original image and the display data after the color reduction processing. Particularly, as the screen size of the electro-optic device increases, the image quality deterioration tends to become distinctive. Hence it is desired to suppress the image quality deterioration as much as possible.

Moreover, in recent years, there is a wide variety of electronic instruments with a lower power consumption. Thus, the screen sizes of the electro-optic devices, mounted as the display units, also widely vary according to the electronic instruments. For instance, size variations of liquid crystal display panels may include QVGA (Quarter Video Graphics Array), HVGA (HalfVGA), and VGA.

In the common drivers, however, there has been a one-to-one correlation between the screen size of the electro-optic device and the capacity of the memory built-in to the driver; hence, it has not been possible for one driver to drive an electro-optic device with 2 or more variations of screen sizes. Moreover, even if the memory capacity is suppressed with the color reduction processing, so that the display data of a larger screen size can be held in the memory, the deterioration of the image quality cannot be suppressed.

### SUMMARY

According to a first aspect of the invention, there is provided a data driver which drives each data line of a plurality of data lines of an electro-optic device based on display data of (i+j) bits (i and j are natural numbers), the data driver comprising:

a memory which previously holds data of j-bit per dot among the display data as retained data; and

a driving section which drives the data line based on the display data,

wherein the driving section drives the data line based on the display data of (i+j) bits, the display data of (i+j) bits being generated by input data of i bits per dot supplied to the data driver, and the retained data read out from the memory.

According to a second aspect of the invention, there is provided an electro-optic device comprising:

a plurality of scanning lines;

a plurality of data lines;

a pixel electrode determined by one of the scanning lines and one of the data lines;

a scanning driver which scans the scanning lines; and

the above-described data driver which drives the each data line of the plurality of data lines.

According to a third aspect of the invention, there is provided an electro-optic device comprising:

a plurality of scanning lines;

a plurality of data lines;

a pixel electrode determined by one of the scanning lines and one of the data lines;

a scanning driver which scans the scanning lines;

the above-described data driver which drives the each data line of the plurality of data lines; and

a processing section which supplies display data to the data driver,

wherein the processing section sets j bits of the display data of (i+j) bits per dot to a memory of the data driver before supplying i-bit data of the display data of (i+j) bits to the data driver.

According to a fourth aspect of the invention, there is provided an electronic instrument comprising the above-described data driver.

According to a fifth aspect of the invention, there is provided an electronic instrument comprising any of the above-described electro-optic devices.

According to a sixth aspect of the invention, there is provided a driving method of driving each data line of a plurality of data lines of an electro-optic device based on display data of (i+j) bits (i and j are natural numbers), the driving method comprising:

previously setting data of j-bit per dot among the display data as retained data in a memory;

receiving input data of i bits per dot;

generating the display data of (i+j) bits by the input data and the retained data; and

driving one of the data lines based on the display data.

### BRIEF DESCRIPTION OF THE SEVERAL VIEWS OF THE DRAWING

FIG. 1 is an illustration showing a schematic structure of an active-matrix liquid crystal display device in the embodiment.

FIG. 2 is an illustration showing a schematic structure of another liquid crystal display device in the embodiment.

FIG. 3 is a block diagram showing an example structure of a scanning driver in FIG. 1.

FIG. 4 is a block diagram of an example structure of a data driver in FIG. 1.

FIG. 5 is an illustration showing a schematic structure of a mode configuration register in FIG. 4.

FIG. 6 is an explanatory illustration of sizes of QVGA, HVGA and VGA.

FIG. 7 is an explanatory illustration of an operation of the data driver in the embodiment that drives the QVGA sized liquid crystal display panel.

FIG. 8 is an explanatory illustration of a first operation of the data driver in the embodiment that drives the HVGA sized liquid crystal display panel.

FIG. 9 is an explanatory illustration of a second operation of the data driver in the embodiment that drives the HVGA sized liquid crystal display panel.

FIG. 10 is an explanatory illustration of a first operation of the data driver in the embodiment that drives the VGA sized liquid crystal display panel.

FIG. 11 is an explanatory illustration of a second operation of the data driver in the embodiment that drives the VGA sized liquid crystal display panel.

FIG. 12 is an explanatory illustration in a case of displaying a static image with the data driver in the embodiment.

FIG. 13 is an explanatory illustration in a case of displaying a moving image with the data driver in the embodiment.

FIG. 14 is a block circuit diagram of an example structure of a line buffer, a line latch, and a data shuffling circuits in FIG. 4.

FIG. 15 is a block circuit diagram of an example structure of a memory and a data complement circuits in FIG. 4.

FIG. 16 is a block circuit diagram of an example structure of a circuit block LB1 in FIG. 14.

FIG. 17 is a circuit diagram of an example structure of a circuit block ML1 in FIG. 16.

FIG. 18 is a circuit diagram of an example structure of a circuit block MSEL in FIG. 16.

FIG. 19 is an explanatory illustration of an operation example of the circuit block MSEL in FIG. 18.

FIG. 20 is a circuit diagram of an example structure of a circuit block ADDG in FIG. 15.

FIG. 21 is a timing chart of an operation example of the circuit block ADDG in FIG. 20.

FIG. 22 is a block circuit diagram of an example structure of a circuit block MEM in FIG. 15.

FIG. 23 is an explanatory illustration of an operation example of a circuit block ADEC in FIG. 22.

FIG. 24 is a block circuit diagram of an example structure of a circuit block DC1 in FIG. 15.

FIG. 25 is a circuit diagram of an example structure of a circuit block DR in FIG. 24.

FIG. 26 is a timing chart of an operation example of the circuit block DR in FIG. 25.

FIG. 27 is a circuit diagram of an example structure of a circuit block DSEL in FIG. 24.

FIG. 28 is a timing chart of an operation example of the circuit block DSEL in FIG. 27.

FIG. 29 is a circuit diagram of an example structure of a reference voltage generation circuit, a Digital to Analog Converter (hereafter DAC), and a driving section in FIG. 4.

FIG. 30 is a block diagram of an example structure of an electronic instrument in the embodiment.

### DETAILED DESCRIPTION OF THE EMBODIMENTS

The advantage of the invention is to provide a data driver, an electro-optic device and an electronic instrument, each of which has the ability to drive electro-optic devices with at least two different screen sizes without image quality deterioration.

According to one embodiment of the invention, there is provided a data driver which drives each data line of a plurality of data lines of an electro-optic device based on display data of (i+j) bits (i and j are natural numbers), the data driver comprising:

a memory which previously holds data of j-bit per dot among the display data as retained data; and

a driving section which drives the data line based on the display data,

wherein the driving section drives the data line based on the display data of (i+j) bits, the display data of (i+j) bits being generated by input data of i bits per dot supplied to the data driver, and the retained data read out from the memory.

In this embodiment, the capacity of the memory that holds the retained data is j bits per dot. Moreover, by performing, per dot, a bit-wise merge on the retained data and the i-bit input data supplied to the data driver, the (i+j)-bit display data is generated.

Therefore, according to this embodiment, even in the case where the built-in memory in the data driver can only hold j bits per dot, each data line can be driven based on the (i+j)-bit display data. Consequently, it is possible to drive an electro-optic device that has a screen size, which requires larger memory capacity than that of the built-in memory, without cutting down the gradation number.

Furthermore, unlike the case of transmitting the one-screen equivalent display data, a part of the display data can be held in the memory; hence not only the power consumption can be lowered by reducing the amount of data transfer, but in addition the production cost can be cut down by decreasing the capacity of the memory.

The data driver may further comprise:

a retained data bit number setting register in which a bit number of the retained data is specified,

wherein the data driver generates the display data of (i+j) bits per dot by performing a bit-wise merge on the input data and the retained data, in accordance with a set value of the retained data bit number setting register.

This enables one data driver to drive an electro-optic device with a larger variety of screen sizes.

The data driver may further comprise:

a line address generation circuit which generates a line address used to read out the retained data from the memory, while refreshing the line address in a cycle of at least two horizontal scanning periods,

wherein the retained data for at least 2 dots is read out from the memory based on the line address; and

wherein the data driver generates the display data of (i+j) bits by performing a bit-wise merge on the input data and a part of the retained data for at least 2 dots, in accordance with a set value of the retained data bit number setting register.

In this data driver,

the retained data may be low order j-bit data of the display data of (i+j) bits, including the least significant bit; and

the input data may be high order i-bit data of the display data of (i+j) bits, including the most significant bit.

The power consumption can be further lowered in the case of displaying natural images, in which the data change in the high bits of the display data is small, since the power consumption caused by the data transfer can further be reduced.

In this data driver,

the retained data may be high order j-bit data of the display data of (i+j) bits, including the most significant bit; and

the input data may be low order i-bit data of the display data of (i+j) bits, including the least significant bit.

This enables power consumption reduction due to the data transfer reduction.

In this data driver,

when a still image is displayed, the driving section may drive the data line based on the display data generated by the input data and the retained data; and

when a moving image is displayed, the driving section may receive an input data of (i+j) bits as the display data, independently from the retained data, and drive the data line based on the display data.

This enables to provide a data driver which displays still images in a low power consumption (as mentioned above), and is capable of displaying moving images.

The data driver may further comprise:

a reference voltage generation circuit that generates 2 (i+j) types of reference voltages; and

a voltage selection circuit which selects one reference voltage as a data voltage from the 2 (i+j) types of reference voltages, based on the display data of (i+j) bits, generated by the input data and the retained data,

wherein the driving section drives the data line based on the data voltage.

According to one embodiment of the invention, there is provided an electro-optic device comprising:

a plurality of scanning lines;

a plurality of data lines;

a pixel electrode determined by one of the scanning lines and one of the data lines;

a scanning driver which scans the scanning lines; and

the above-described data driver which drives the each data line of the plurality of data lines.

According to one embodiment of the invention, there is provided an electro-optic device comprising:

a plurality of scanning lines;

a plurality of data lines;

a pixel electrode determined by one of the scanning lines and one of the data lines;

a scanning driver which scans the scanning lines;

the above-described data driver which drives the each data line of the plurality of data lines; and

a processing section which supplies display data to the data driver,

wherein the processing section sets j bits of the display data of (i+j) bits per dot to the memory of the data driver before supplying i-bit data of the display data of (i+j) bits to the data driver.

This enables to provide an electro-optic device including a data driver which has the ability to drive an electro-optic device with at least two different screen sizes without image quality deterioration.

According to one embodiment of the invention, there is provided an electronic instrument comprising the above-described data driver.

According to one embodiment of the invention, there is provided an electronic instrument comprising any of the above-described electro-optic devices.

This enables to provide an electronic instrument including a data driver that has the ability to drive an electro-optic device with at least two different screen sizes without image quality deterioration.

According to one embodiment of the invention, there is provided a driving method of driving each data line of a plurality of data lines of an electro-optic device based on display data of (i+j) bits (i and j are natural numbers), the driving method comprising:

previously setting data of j-bit per dot among the display data as retained data in a memory;

receiving input data of i bits per dot;

generating the display data of (i+j) bits by the input data and the retained data; and

driving one of the data lines based on the display data.

The driving method may further comprise:

reading out the retained data for at least 2 dots from the memory, in a cycle of at least two horizontal scanning periods; and

generating the display data of (i+j) bits per dot by performing a bit-wise merge on the input data and a part of the retained data for at least 2 dots.

In this driving method,

the retained data may be low order j-bit data of the display data of (i+j) bits, including the least significant bit; and

the input data may be high order i-bit data of the display data of (i+j) bits, including the most significant bit.

In this driving method,

the retained data may be high order j-bit data of the display data of (i+j) bits, including the most significant bit; and

the input data may be low order i-bit data of the display data of (i+j) bits, including the least significant bit.

In this driving method,

when a still image is displayed, the data line may be driven based on the display data generated by the input data and the retained data; and

when a moving image is displayed, an input data of (i+j) bits may be received as the display data, independently from the retained data, and the data line may be driven based on the display data.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Electro-Optic Device

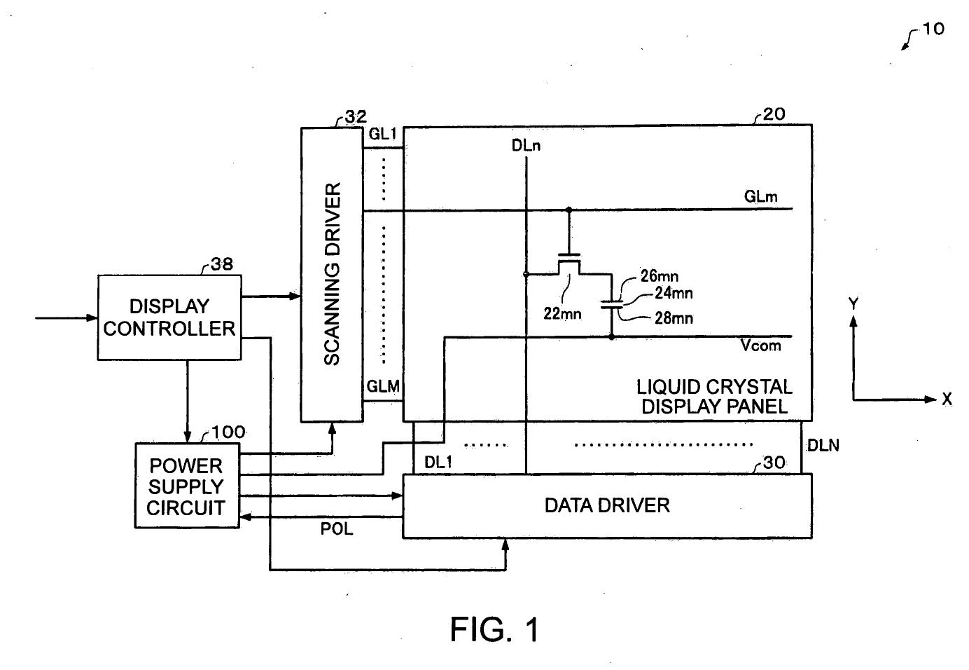

In FIG. 1, a schematic structure of an active-matrix liquid crystal display device in the embodiment is shown. In FIG. 1, the description of the electro-optic device refers to the liquid crystal display device, in which the active-matrix liquid crystal display panel is employed, while the electro-optic device may also include a liquid crystal display device, in which a passive-matrix liquid crystal display panel is employed. The electro-optic device according to the embodiment of the invention shall not be limited to the liquid crystal display panel.

A liquid crystal display device 10 includes a liquid crystal display panel 20 (in a broader sense, a display panel; and in a further broader sense, an electro-optic device). A liquid crystal display panel 20 is formed on, for instance, a glass substrate. On the glass substrate, scanning lines (gate lines) GL1 through GLM, and data lines (source lines) DL1 through DLN are arranged, where the scanning lines are arrayed in multiple lines in the direction of the Y-axis, and each one is stretched in the direction of the X-axis; and the data signal supply lines are arrayed in multiple lines in the direction of the X-axis, and each one is stretched in the direction of the Y-axis. Here, M and N are integers equal to or larger than 2. Corresponding to an intersection of the scanning line GLm (hereafter, m is an integer satisfying 1≦m≦M) and the data line DLn (hereafter, n is an integer satisfying 1≦n≦N), a pixel region (pixel) is provided, in which a thin-film transistor (hereafter TFT) 22 mn is arranged.

The gate of the TFT22 mn is connected to the scanning line GLm. The source of the TFT22 mn is connected to the data line DLn. A drain of the TF122 mn is connected to a pixel electrode 26 mn. Between the pixel electrode 26 mn and a counter electrode 28 mn that faces it, liquid crystal (in a broader sense, electro-optic material) is filled in, forming a liquid crystal capacitor 24 mn (in a broader sense, a liquid crystal element). Corresponding to the voltage applied between the pixel electrode 26 mn and the counter electrode 28 mn, the transmittance of the pixel changes. A counter electrode voltage Vcom is supplied to the counter electrode 28 mn.

Such liquid crystal display panel 20 is formed, for instance, by adhering a first substrate on which the pixel electrodes and the TFTs are formed, to a second substrate on which the counter electrodes are formed, then filling in the liquid crystal, which is the electro-optic material, between the two substrates.

The liquid crystal display device 10 includes a data driver 30. The data driver 30 drives the data lines DL1 through DLN in the liquid crystal display panel 20, based on the display data (gradational data).

The liquid crystal display device 10 may include a scanning driver 32 (in a narrower sense, a gate driver). The scanning driver 32 sequentially drives (scans) the scanning lines GL1 through GLM in the liquid crystal display panel 20, during one vertical scanning period.

The liquid crystal display device 10 includes a power supply circuit 100. The power supply circuit 100 generates voltages necessary for driving the data lines, and supplies them to the data driver 30. The power supply circuit 100 generates voltages, such as, for instance, source voltages VDDH and VSSH that are necessary for driving the data lines of the data driver 30, or a voltage for a logic unit of the data driver 30. The power supply circuit 100 also generates a voltage necessary for scanning the scanning line, and supplies it to the gate driver 32.

Moreover, the power supply circuit 100 includes a counter electrode voltage supply circuit, and this generates the counter electrode voltage Vcom. More specifically, the power supply circuit 100 outputs the counter electrode voltage Vcom to the counter electrode of the liquid crystal display panel 20, adjusted according to a timing of a polarity inversion signal POL generated by the data driver 30, where the counter electrode voltage Vcom repetitively takes two levels of high-potential voltage VCOMH and low-potential voltage VCOML periodically.

The liquid crystal display device 10 may also include a display controller 38. The display controller 38 controls the data driver 30, the scanning driver 32, and the power supply circuit 100, in accordance with what is set by a host such as a Central Processing Unit (hereafter CPU) (not shown). For example, the display controller 38 sets the operation mode, the polarity inversion drive, and the polarity inversion timing, and supplies internally-generated vertical synchronization signals and horizontal synchronization signals, to the data driver 30 and the scanning driver 32. In a broader sense, the display controller 38 and the host may be called a processing section.

In FIG. 1, the liquid crystal display device 10 is configured to include the power supply circuit 100 or the display controller 38, while at least one of them may also be installed outside the liquid crystal display device 10. Alternatively, the liquid crystal display device 10 may also be configured to include the host.

Further, at least one of the scanning driver 32 and the power supply circuit 100 may also be built-in to the data driver 30.

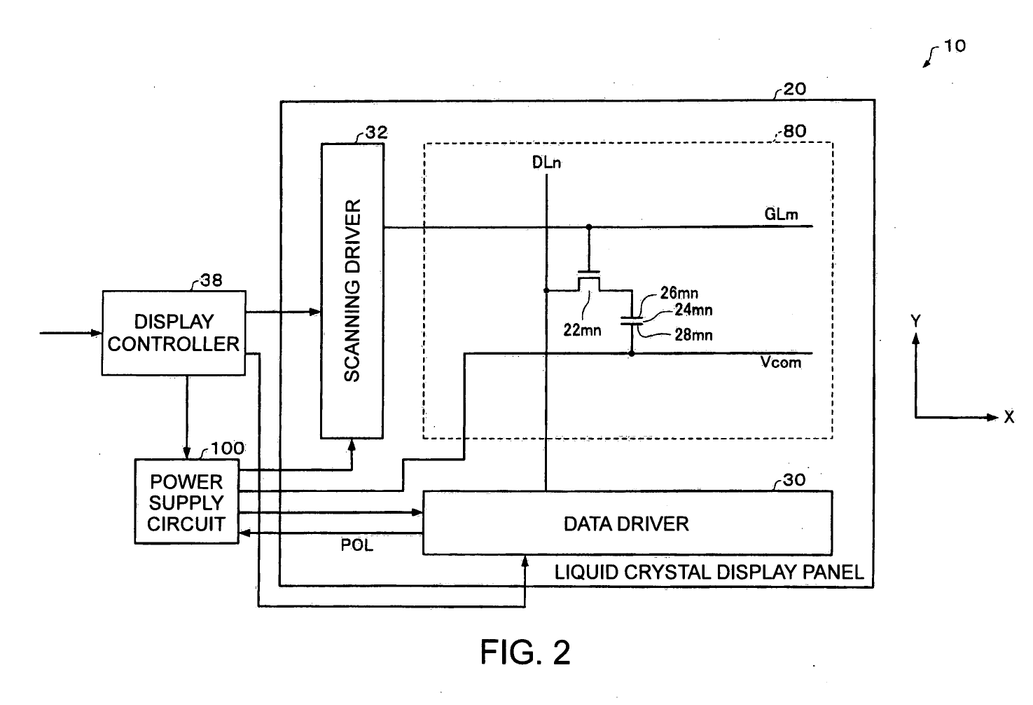

Still further, any one of (or all of) the data driver 30, scanning driver 32, display controller 38 or power supply circuit 100, may be formed on the liquid crystal display panel 20. For example, in FIG. 2, the data driver 30 and the scanning driver 32 are formed on the liquid crystal display panel 20. As described, the liquid crystal display panel 20 may include: a plurality of scanning lines, a plurality of data lines, a pixel (pixel electrode) determined by one of the plurality of scanning lines and one of the plurality of data lines, a scanning driver that scans the plurality of scanning lines, and a data driver that drives the plurality of data lines. The plurality of pixels is formed in a pixel-forming region 80 of the liquid crystal display panel 20.

2. Scanning Driver

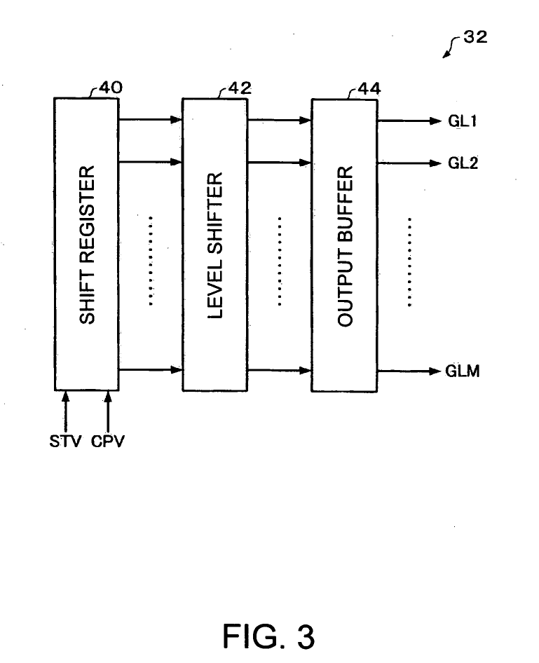

In FIG. 3, an example structure of the scanning driver 32 in FIG. 1 is shown.

The scanning driver 32 includes a shift register 40, a level shifter 42, and an output buffer 44.

The shift register 40 is installed in correspondence with each scanning line, and includes a plurality of sequentially connected flip-flops. The shift register 40 retains a start pulse signal STV in the flip-flop in synchronization with a clock signal CPV; then, it sequentially shifts the start pulse signal STV to the adjacent flip-flop in synchronization with the clock signal CPV. Here, the input clock signal CPV is the horizontal synchronization signal, and the start pulse signal STV is the vertical synchronization signal.

The level shifter 42 shifts the voltage level provided from the shift register 40, to the level corresponding to the transistor capacity of the liquid crystal element and of the TFT in the liquid crystal display panel 20. A high voltage level, from 20V to 50V for instance, is required for this voltage level.

The output buffer 44 buffers a scanning voltage shifted by the level shifter 42, and outputs it to the scanning lines; thereby driving the scanning lines.

3. Data Driver

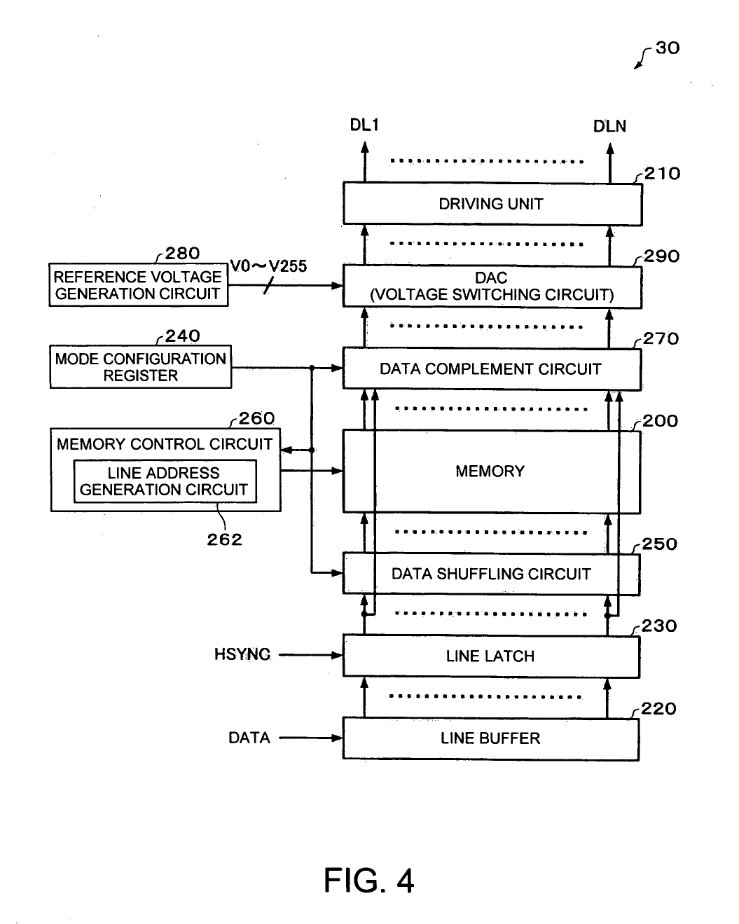

In FIG. 4, a block diagram of an example structure of the data driver 30 in FIG. 1 is shown.

The data driver 30 includes a memory 200 and a driving section 210, and drives each of the data lines DL1 through DLN, based on the (i+j)-bit display data, where both i and j are natural number. The memory 200 holds in advance, the j-bit data, which is part of the (i+j)-bit display data, as retained data. The (i+j)-bit display data is generated by the i-bit input data, which is, externally supplied for instance, to the data driver 30, as well as by the retained data read out from the memory 200. The driving section 210 drives each data line based on the (i+j)-bit display data.

In general, the memory built in to the data driver can hold the display data for one screen of the liquid crystal display panel (a drive target). Therefore, the required amount of memory, the memory being built-in to the data driver, is (i+j)×N×M bits, where M is the number of scanning lines, N is the number of data lines, and (i+j) is the number of bits per one dot in the display data. In contrast, in the data driver 30 in FIG. 4, even when the amount of memory required for the memory 200 is merely j×N×M bits, the gradation number per one dot can be the same as that of (i+j)×N×M bits. Consequently, it is possible to provide the data driver 30 that allows low cost and low power consumption, while preventing image quality deterioration.

Moreover, the data driver 30 includes the retained data bit number setting register, which can specify the number of bits of retained data held in the memory 200. In accordance with the set value of the retained data bit number setting register, (i+j)-bit per dot display data can be generated by performing a bit-wise merge on the input data and the retained data. Hence, even in the case where the capacity of the memory 200 is fixed, only the part of the (i+j)-bit display data can be held in the memory 200 as the retained data, in accordance with the screen size of the liquid crystal display panel 20.

For instance, in the case of the memory 200, holding the display data equivalent to one screen of the QVGA size liquid crystal display panel 20, is described. Here, the liquid crystal display panel 20 with sizes such as HVGA and VGA can be driven by holding only the part of the one-dot equivalent display data in the memory 200, without cutting down the gradation number.

It is desirable, in such data driver 30, that: in the case of displaying a still image, the driving section 210 drives the data line, based on the display data generated by the input data and the retained data; and, in the case of displaying a moving image, the driving section 210 receives, independently from the retained data, input data of (i+j) bits, and drive the data line based on the display data,

In the case of still images, the display data for one screen scanning can be used in a fixed manner; thus only the j-bit data, which is part of the display data for one dot, is held in advance as a retained data in the memory 200. Therefore, it is sufficient that the display controller 38 supply only the i-bit display data to the data driver 30.

In contrast, in the case of moving images, unlike the case of still images, the display data supplied from the display controller 38 can be used directly, without using the retained data held in the memory 200, since the display data needs to be modified in a given cycle.

Consequently, in the case of still images, the amount of transmission of display data, which needs to be supplied by the display controller 38, can be reduced, and thereby the power consumption can be reduced by a similar degree. At the same time, the signal line connected to the display controller 38 need not be modified; hence the data driver that can display a moving image as is can be provided. Further, since there is no need to reduce the gradation number in both cases of still images and moving images, the image quality does not deteriorate.

It is desirable that the retained data be composed of the low order j-bit data of the display data of (i+j) bits, including the least significant bit; and the input data be composed of the high order i-bit data of the display data of (i+j) bits, including the most significant bit. Particularly, in the case of displaying a still image, the data change frequency of the high order i-bit data of the display data, which is supplied from the display controller 38, is lower than that of the low order j-bit data; hence the power consumption caused by data driving, every time the data to be supplied changes, can be reduced.

Moreover, it may also be desirable that the retained data be composed of the first-j bit data of the display data of (i+j) bits, including the most significant bit; and the input data be composed of the low order i-bit data of the display data of (i+j) bits, including the least significant bit. In this case, the amount of data transfer that the display controller 38 needs to supply can be reduced; thereby contributing to the reduction of the power consumption.

Hereafter, the example structure of the data driver 30 shown in FIG. 4 will be described.

In FIG. 4, the data driver 30 includes a line buffer 220 and a line latch 230, besides the memory 200 and the driving section 210.

The data supplied from the display controller 38 is temporarily stored in the line buffer 220. The data is either the i-bit display data for displaying a still image, the j-bit display data for writing in to the memory 200, or the (i+j)-bit display data for displaying a moving image. For example, in the case of displaying a still image by holding the retained data in advance in the memory 200, the display controller 38 outputs the (i+j)-bit display data as is to the data driver 30, and the data driver 30 does not receive the j-bit display data, which is a part of the (i+j)-bit display data from the display controller 38. This way, the display controller with common function can be used without providing additional function to the display controller 38.

The display data is input serially in the pixel unit (or single dot unit) to the data driver 30. This display data is input in synchronization with dot clock signal DCLK. The line buffer 220 retrieves the display data required in at least one horizontal scanning.

The line latch 230 latches the display data retrieved into the line buffer 220 at the change timing of a horizontal synchronization signal HSYNC.

Moreover, the data driver 30 includes a mode configuration register 240. The set value of the mode configuration register 240 is set by the display controller 38 or the host (not shown).

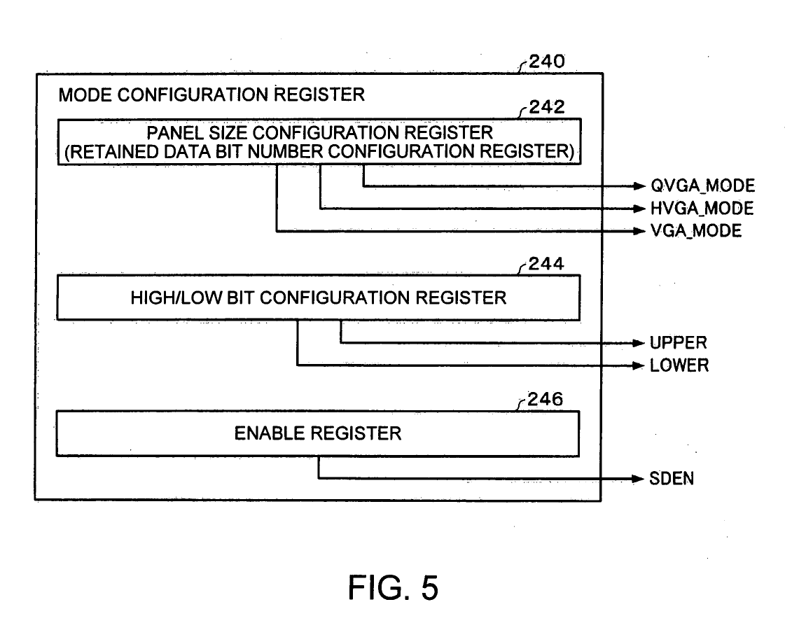

In FIG. 5, a schematic view of the example structure of the mode configuration register 240 in FIG. 4 is shown.

The mode configuration register 240 includes a panel size configuration register 242 that serves as the retained data bit number setting register, a high/low bit configuration register 244, and an enable register 246.

The set value for specifying the screen size of the liquid crystal display panel 20, which is a drive target of the data driver 30, is set in the panel size configuration register 242. The bit number j, which represents the number of bits of the one-dot equivalent retained data in the memory 200 is modified in accordance with the set value.

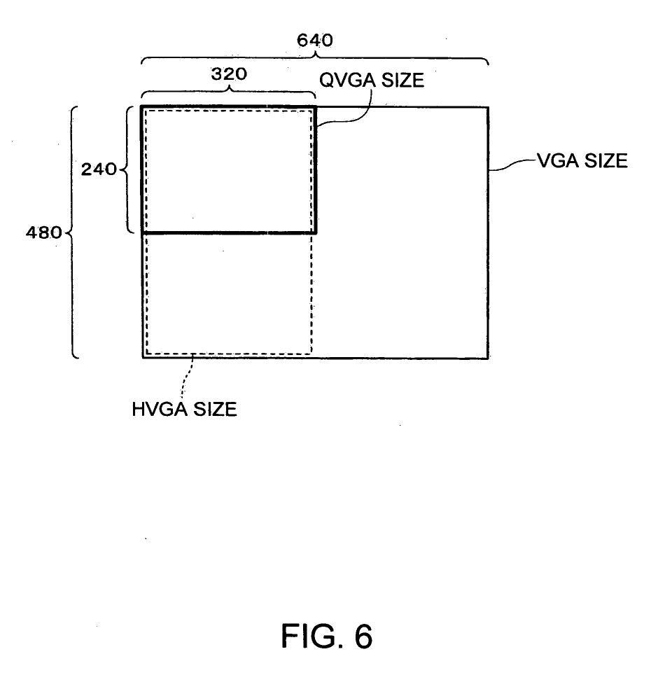

The memory 200 of the data driver 30 in the embodiment has enough capacity to hold the display data for one screen of QVGA size shown in FIG. 6. Moreover, in the embodiment, any one of the sizes QVGA, HVGA, and VGA can be specified in the panel size configuration register 242.

If the QVGA size is specified by the panel size configuration register 242, the output sets QVGA_MODE at H-level, and HVGA_MODE and VGA_MODE at L-level. If the HVGA size is specified by the panel size configuration register 242, the VGA_MODE is at the H-level, and the QVGA_MODE and the VGA_MODE are at the L-level. If the VGA size is specified by the panel size configuration register 242, the VGA_MODE is at the H-level, and the QVGA_MODE and the HVGA_MODE are at the L-level.

In the high/low bit configuration register 244, a set value is set, in order to specify the bit number j of the j-bit data, which is a part of the (i+j)-bit display data, and which is to be retained in the memory 200, to be either at the high-bit side including the most significant bit, or at the low-bit side including the least significant bit. In the case of holding the high-bit side of the display data held in the memory 200, an UPPER is at the H-level, and a LOWER is at the L-level. In the case of holding the low-bit side of the display data held in the memory 200, the UPPER is at the L-level, and the LOWER is at the H-level.

There is a set value set in the enable register 246, which specifies either to: perform the bit-wise merge on the i-bit input data and the j-bit retained data, and generate, the (i+j)-bit per dot display data; or set the (i+j)-bit per dot input data as the display data. If the retained data is used, then SDEN is at the H-level, and if the retained data is ignored, then the SDEN is at the L-level.

Incidentally, as shown in FIG. 6, there are 320 pixels×240 scanning lines of the QVGA size, while there are 320 pixels×480 scanning lines and 640 pixels×480 scanning lines, for the HVGA size and the VGA size respectively. In other words, the size of HVGA is twice as large as that of the QVGA, and VGA is four times as large as that of the QVGA.

If the display data, of which the amount is equivalent to what is required for displaying of the HVGA sized screen, is to be held in the memory 200 with the capacity equivalent to the amount for the QVGA sized screen, then the number of bits per dot that can be held is half of that of the QVGA. If the display data, of which the amount is equivalent to what is required for displaying of the VGA sized screen, is to be held in the memory 200, then the number of bits per dot that can be held is one fourth of that of the QVGA.

Therefore, the data driver 30 includes a data shuffling circuit 250, as shown in FIG. 4. The data shuffling circuit 250 conducts a processing of data shuffling in accordance with the set value of the panel size configuration register 242, in order to hold the data, supplied from the line latch 230, in the memory 200. In other words, the data shuffling circuit 250 can conduct a data shuffle processing in accordance with the set value of the panel size configuration register 242 and the high/low bit configuration register 244.

In the following example, the bit number (i+j) of the display data per dot is 8, and i and j are both 4. If the QVGA_MODE is at the H-level, then the processing of outputting the display data, which is latched in the line latch 230, to the memory 200 as is (8-bit per dot), is conducted. If the HVGA_MODE is at the H-level, the following processing is performed: performing the bit-wise merge on sets of the first 4 bits (or on sets of the last 4 bits) of adjacent sets of display data for 2 dots, which are latched to the line latch 230 and are adjacent in the scanning direction (horizontal scanning direction); and outputting the result to the memory 200 as an 8-bit data. If the VGA_MODE is at the H-level, the following processing is performed: performing the bit-wise merge on sets of the first 2 bits (or on sets of the last 2 bits) of the adjacent sets of four-dot equivalent display data (display data for 4 dots), which are latched to the line latch 230 and are adjacent in the scanning direction (horizontal scanning direction); and outputting the result to the memory 200 as the 8-bit data.

Moreover, the data driver 30 includes a memory control circuit 260. The memory control circuit 260 determines the address to perform a write-in of the data, output from the data shuffling circuit 250, as a retained data.

The memory control circuit 260 includes a line address generation circuit 262. The line address generation circuit 262 generates a line address for determining the retained data that is read out from the memory 200. More specifically, the line address generation circuit 262 generates the new line address while refreshing the previous one, in a cycle of which the period is equal to one or several horizontal scanning periods corresponding to the set value of the panel size configuration register 242. In other words, the line address generation circuit 262 can generate the new line address while refreshing the previous one, in a cycle of which the period is equal to one or several horizontal scanning periods, corresponding to the set value of the panel size configuration register 242, and that of the high/low bit configuration register 244.

In FIG. 4, the memory 200 is compliant to the QVGA size; hence every time one line address is specified, the 8-bit display data is read out per dot. Hence, if the QVGA_MODE is at the H-level, then the 8-bit display data that is read out can be used as is. Further, if the HVGA_MODE is at the H-level, the 8-bit display data that is read out is equivalent to 2 dots. Still further, if the VGA_MODE is at the H-level, the 8-bit display data that is read out is equivalent to 4 dots. Consequently, when refreshing the line address, if the HVGA_MODE is at the H-level, then the refreshing is conducted every two horizontal scanning periods, and if the VGA_MODE is at the H-level, then the refreshing is conducted every four horizontal scanning periods. In each horizontal scanning period, data for each dot being read out is used as part of the display data.

This way, the bit-wise merge is performed on the input data and the part of the retained data read out every time when one line address is specified; thereby serving as the 8-bit display data for driving the data line.

Due to the above, the data driver 30 further includes a data complement circuit 270. The data complement circuit 270 sets a data, where the number of bits i of the data from the line latch 230 is 4, as an input data, and performs the bit-wise merge on the input data and the part of the retained data read out (as described above) from the memory 200. This input data bypasses the data shuffling circuit 250 and the memory 200, and thereafter is supplied to the data complement circuit 270. As described, the 4-bit retained data corresponding to the 4-bit input data from the line latch 230 is read out from the memory 200, hence the 8-bit display data of the original image is generated.

This way, the data complement circuit 270 generates the 8-bit display data by performing the bit-wise merge on the input data and the retained data, in accordance with the panel size configuration register 242. More specifically, the data complement circuit 270 can generate the 8-bit display data by performing the bit-wise merge on the input data and the retained data, in accordance with the set values of the panel size configuration register 242 and the high/low bit configuration register 244.

As described above, if the QVGA_MODE is at the H-level, then the line address generation circuit 262 refreshes the line address for reading out the retained data from the memory 200, in a cycle of one horizontal scanning period. At the same time, if the HVGA_MODE or the VGA_MODE is at the H-level, the line address generation circuit 262 refreshes the line address in the cycle of two or four horizontal scanning period respectively.

In other words, the line address generation circuit 262 can perform the generation with a refresh cycle of at least two horizontal scanning periods. In this case, the (i+j)-bit display data can be generated by: reading out the 2-dot equivalent retained data from the memory 200, based on the line address; and performing a bit-wise merge on the input data and the part of the 2-dot equivalent retained data, in accordance with the set value of the panel size configuration register 242 (retained data bit number setting register).

The data driver 30 further includes a reference voltage generation circuit 280, and DAC (in a broader sense, the voltage selection circuit) 290.

The reference voltage generation circuit 280 generates a plurality of reference voltages, where each reference voltage corresponds to the 8-bit display data. More specifically, the reference voltage generation circuit 280 generates the plurality of reference voltages V0 through V255, each of which corresponds to each 8-bit display data, based on a source voltage VDDH at a high potential, and on the source voltage VSSH at a low potential.

The DAC 290 generates data voltages for every output line, the data voltages corresponding to the display data, generated from the data complement circuit 270. More specifically, the DAC 290 selects the reference voltage that corresponds to the one-output-line equivalent display data, which is output from the data complement circuit 270, from the plurality of reference voltages V0 through V255 that are generated by the reference voltage generation circuit 280; and then outputs the selected reference voltage as the data voltage. In other words, the DAC 290 selects the reference voltage corresponding to each display data from the 2⁽ⁱ⁺ⁱ⁾ types of reference voltages, and outputs it as the data voltage.

The driving section 210 drives the plurality of output lines, each of which is connected to a data line of the liquid crystal display panel 20. More specifically, the driving section 210 drives each output line, based on the data voltage generated per every output line by the DAC 290. That is to say, the driving section 210 drives the data line based on the data voltage, having the reference voltage as the data voltage, the reference voltage being selected based on the display data. The driving section 210 has an operational amplifier, which is installed in every output line, and to which a voltage follower is connected; and the operational amplifier drives each output line based on the data voltage from the DAC 290.

3.1 Operations Complying with Panel Size

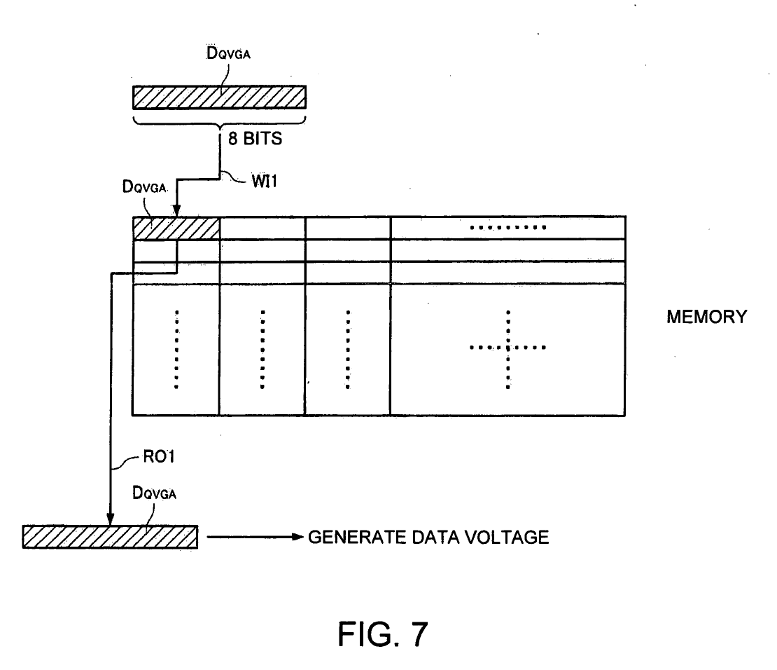

In FIG. 7, an explanatory illustration of an operation of the data driver 30 in the embodiment when driving the QVGA sized liquid crystal display panel is shown.

In the case where the QVGA_MODE is set at the H-level by the panel size configuration register 242, the 8-bit per dot display data D_{QVGA} is sequentially retrieved from the display controller 38 to the line buffer 220. Then, the 8-bit display data D_{QVGA} that is retrieved to the line latch 230 is written straight in to the given write-in region in the memory 200 (W11). Thereafter, based on the line address specified while being adjusted according to the display timing, the display data D_{QVGA} is read out (RO1), and the data voltage corresponding to the display data D_{QVGA} is generated.

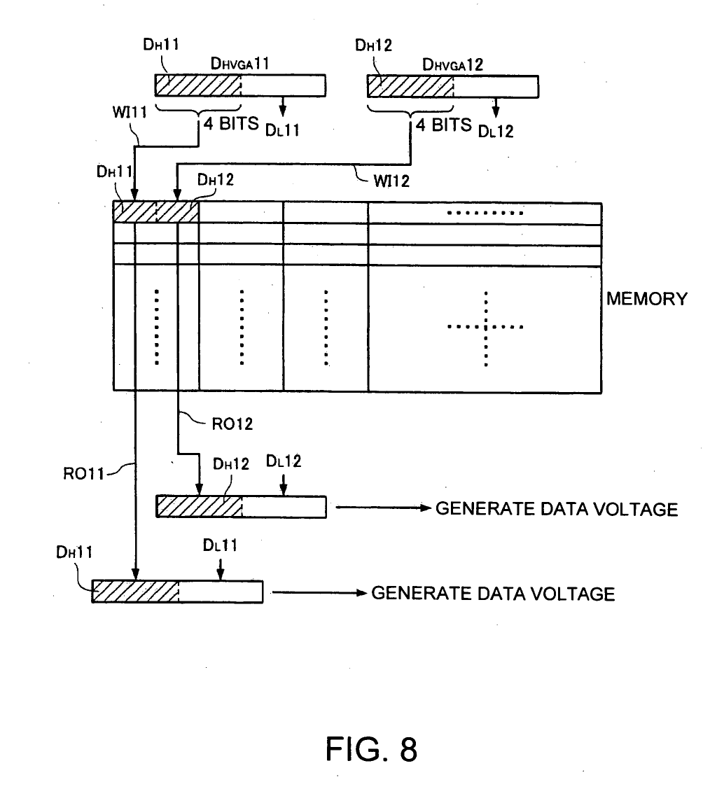

In FIG. 8, an explanatory illustration of a first operation of the data driver 30 in the embodiment when driving the HVGA sized liquid crystal display panel is shown. In FIG. 8, the operation when the UPPER is at the H-level is shown.

In the case where the HVGA_MODE is set at the H-level by the panel size configuration register 242, the 2 sets of 8-bit per dot display data D_{HVGA}11 and D_{HVGA}12 are sequentially retrieved from the display controller 38 to the line buffer 220. Then, each of the first 4 bits from the 2 sets of display data D_{HVGA}11 and D_{HVGA}12, both of which are retrieved into the line latch 230, is written in to the given write-in region in the memory 200 (WI11, WI12). That is to say, the first 4-bit data D_{H}11 of the display data D_{HVGA}11 and the first 4-bit data D_{H}12 of the display data D_{HVGA}12, are written in to the write-in region of the display data D_{QVGA} in FIG. 7. In other words, part of each two-dot equivalent display data is held, when the HVGA_MODE is at the H-level, to the region where the one-dot equivalent display data is held when the QVGA_MODE is at the H-level.

Thereafter, based on the line address refreshed every two horizontal scanning periods, it's timing being adjusted according to the display timing, 4 bits of 2 data sets D_{H}11 and D_{H}12 are read out (RO11, and RO12).

Then, the last 4-bit data D_{L}11 of the display data D_{HVGA}11 is supplied from the display controller 38 as the input data, and the bit-wise merge is performed on the data D_{H}11 and the data D_{L}11, thereby generating the display data D_{HVGA}11. Finally, the data voltage corresponding to the display data D_{HVGA}11 is generated. Further, the last 4-bit data D_{L}12 of the display data D_{HVGA}12 is supplied from the display controller 38 as the input data, and the bit-wise merge is performed on the data D_{H}12 and the data D_{L}12, thereby generating the display data D_{HVGA}12. Finally, the data voltage corresponding to the display data D_{HVGA}12 is generated.

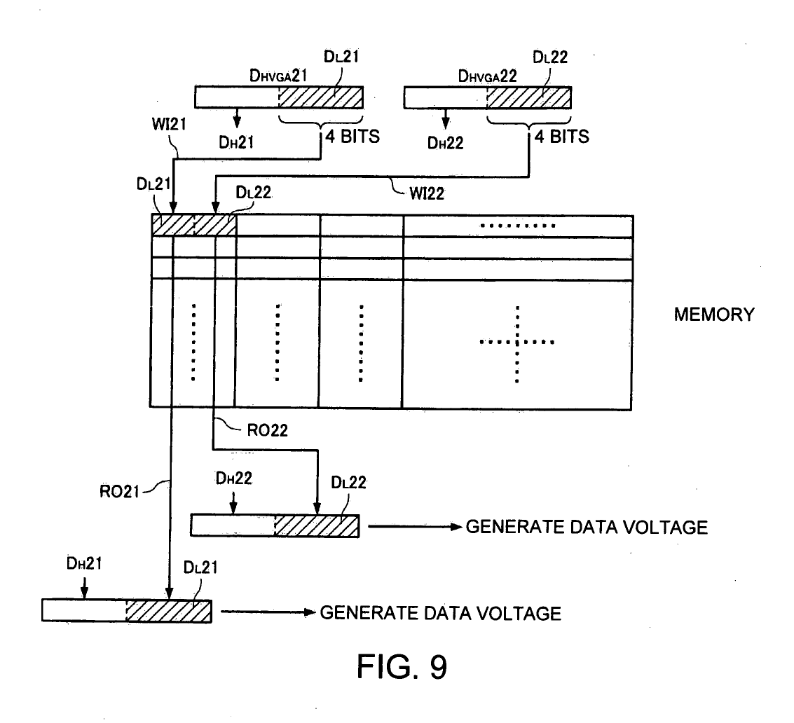

In FIG. 9, an explanatory illustration of a second operation of the data driver 30 in the embodiment when driving the HVGA sized liquid crystal display panel is shown. In FIG. 9, the operation when the LOWER is at the H-level is shown.

In the case where the HVGA_MODE is set at the H-level by the panel size configuration register 242, the 2 sets of 8-bit per dot display data D_{HVGA}21 and D_{HVGA}22 are sequentially retrieved from the display controller 38 to the line buffer 220. Then, each of the last 4 bits from the 2 sets of display data D_{HVGA}21 and D_{HVGA}22, both of which are retrieved into the line latch 230, is written in to the given write-in region in the memory 200 (WI21, WI22). That is to say, the last 4-bit data D_{L}21 of the display data D_{HVGA}21 and the last 4-bit data D_{L}22 of the display data D_{HVGA}22, are written in to the write-in region of the display data D_{QVGA} in FIG. 7.

Thereafter, based on the line address refreshed every two horizontal scanning periods, it's timing being adjusted according to the display timing, 4 bits of 2 data sets D_{L}21 and D_{L22} are read out (RO21, and RO22).

Then, the first 4-bit data D_{H}21 of the display data D_{HVGA}21 is supplied from the display controller 38 as the input data, and the bit-wise merge is performed on the data D_{H}21 and the data D_{L}21, thereby generating the display data D_{HVGA}21. Finally, the data voltage corresponding to the display data D_{HVGA}21 is generated. Further, the first 4-bit data D_{H}22 of the display data D_{HVGA}22 is supplied from the display controller 38 as the input data, and the bit-wise merge is performed on the data D_{H}22 and the data D_{L}22, thereby generating the display data D_{HVGA}22. Finally, the data voltage corresponding to the display data D_{HVGA}22 is generated.

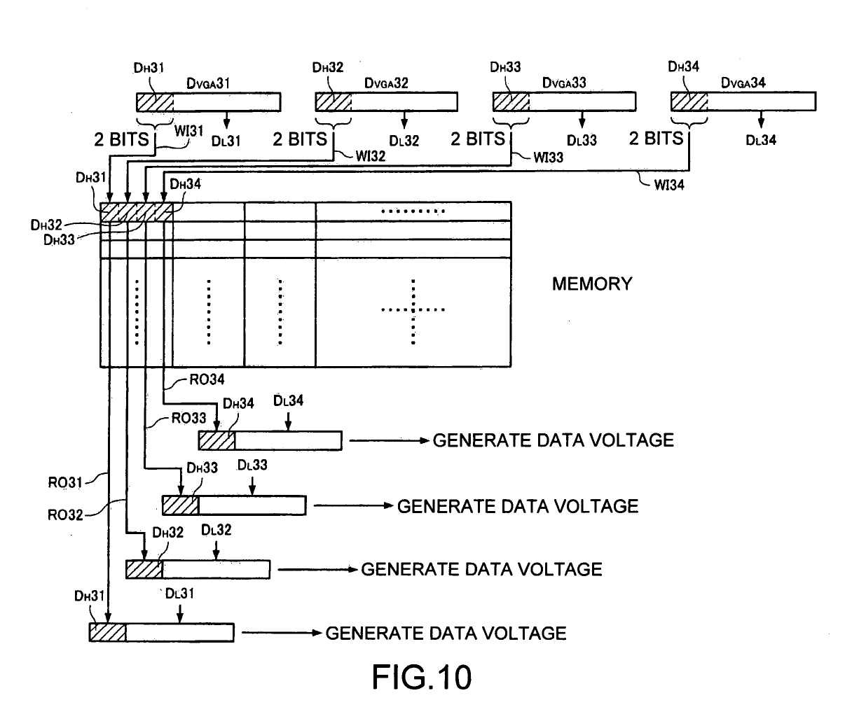

In FIG. 10, an explanatory illustration of a first operation of the data driver 30 in the embodiment when driving the VGA sized liquid crystal display panel is shown. In FIG. 10, the operation when the UPPER is at the H-level is shown.

In the case where the VGA_MODE is set at the H-level by the panel size configuration register 242, the 4 sets of 8-bit per dot display data D_{VGA}31, D_{VGA}32, D_{VGA}33, and D_{VGA}34 are sequentially retrieved from the display controller 38 to the line buffer 220. Then, each of the first 2 bits from the 4 sets of display data D_{VGA}31, D_{VGA}32, D_{VGA}33, and DVGA³⁴, each of which are retrieved into the line latch 230, is written in to the given write-in region in the memory 200 (WI31, WI32, WI33, and WI34). That is to say, the first 2-bit data D_{H}31 of the display data D_{VGA}31, the first 2-bit data DH32 of the display data D_{VGA}32, the first 2-bit data DH33 of the display data D_{VGA}33, and the first 2-bit data D_{H}34 of the display data D_{VGA}34 are written in to the write-in region of the display data D_{QVGA} in FIG. 7. In other words, part of each four-dot equivalent display data is held, when the VGA_MODE is at the H-level, to the region where the one-dot equivalent display data is held when the QVGA_MODE is at the H-level.

Thereafter, based on the line address refreshed every four horizontal scanning periods, it's timing being adjusted according to the display timing, 2 bits of 4 data sets D_{H}31, D_{H}32, D_{H}33, and D_{H}34 are read out (RO31, RO32, RO33, and RO34).

Then, the last 6-bit data D_{L}31 of the display data D_{VGA}31 is supplied from the display controller 38 as the input data, and the bit-wise merge is performed on the data D_{H}31 and the data D_{L}31, thereby generating the display data D_{VGA}31. Consequently, the data voltage corresponding to the display data D_{VGA}31 is generated.

Further, the last 6-bit data D_{L}32 of the display data D_{VGA}32 is supplied from the display controller 38 as the input data, and the bit-wise merge is performed on the data D_{H}32 and the data D_{L}32, thereby generating the display data D_{VGA}32. Consequently, the data voltage corresponding to the display data D_{VGA}32 is generated.

Still further, the last 6-bit data D_{L}33 of the display data D_{VGA}33 is supplied from the display controller 38 as the input data, and the bit-wise merge is performed on the data D_{H}33 and the data D_{L}33, thereby generating the display data D_{VGA}33. Consequently, the data voltage corresponding to the display data D_{VGA}33 is generated.

Moreover, the last 6-bit data D_{L}34 of the display data D_{VGA}34 is supplied from the display controller 38 as the input data, and the bit-wise merge is performed on the data D_{H}34 and the data D_{L}34, thereby generating the display data D_{VGA}34. Consequently, the data voltage corresponding to the display data D_{VGA}34 is generated.

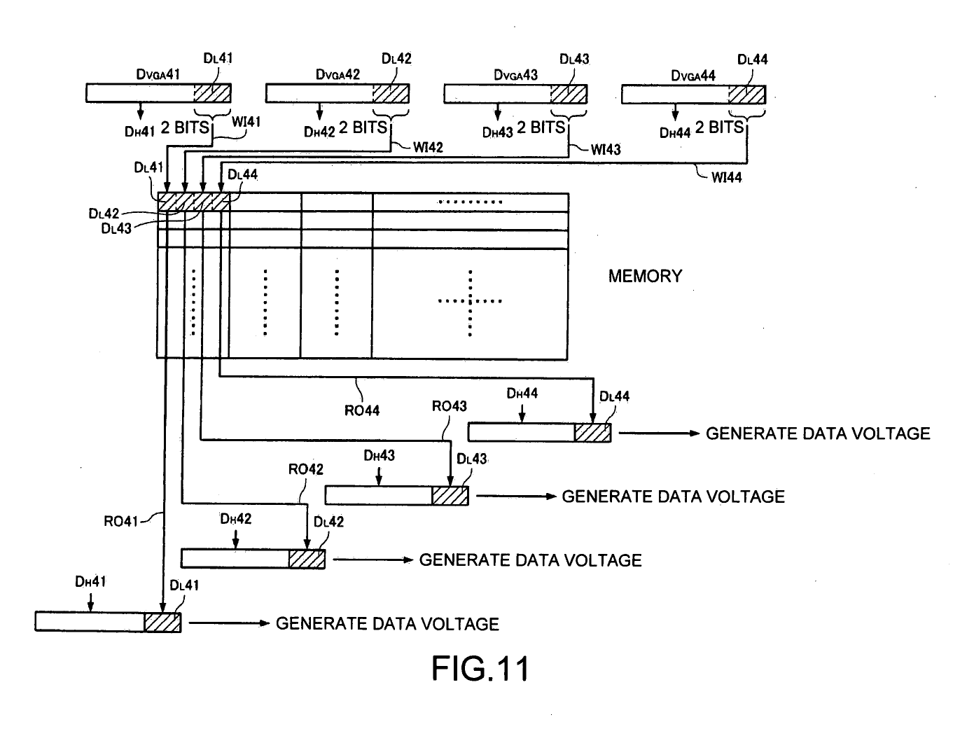

In FIG. 11, an explanatory illustration of a second operation of the data driver 30 in the embodiment when driving the VGA sized liquid crystal display panel is shown.

In FIG. 11, the operation when the LOWER is at the H-level is shown.

In the case where the VGA_MODE is set at the H-level by the panel size configuration register 242, the 4 sets of 8-bit per dot display data D_{VGA}41, D_{VGA}42, D_{VGA}43, and D_{VGA}44 are sequentially retrieved from the display controller 38 to the line buffer 220. Then, each of the last 2 bits from the 4 sets of display data D_{VGA}41, D_{VGA}42, D_{VGA}43, and D_{VGA}44, each of which are retrieved into the line latch 230, is written in to the given write-in region in the memory 200 (WI41, WI42, WI43, and WI44). That is to say, the last 2-bit data D_{L}41 of the display data D_{VGA}41, the last 2-bit data D_{L}42 of the display data D_{VGA}42, the last 2-bit data D_{L}43 of the display data D_{VGA}43, and the last 2-bit data D_{L}44 of the display data D_{VGA}44 are written in to the write-in region of the display data D_{QVGA} in FIG. 7.

Thereafter, based on the line address refreshed every four horizontal scanning periods, it's timing being adjusted according to the display timing, 2 bits of 4 data sets D_{L}41, D_{L}42, D_{L}43, and D_{L}44 are read out (RO41, RO42, RO43, and RO44).

Then, the first 6-bit data D_{H}41 of the display data D_{VGA}41 is supplied from the display controller 38 as the input data, and the bit-wise merge is performed on the data D_{H}41 and the data D_{L}41, thereby generating the display data D_{VGA}41. Consequently, the data voltage corresponding to the display data D_{VGA}41 is generated.

Further, the first 6-bit data D_{H}42 of the display data D_{VGA}42 is supplied from the display controller 38 as the input data, and the bit-wise merge is performed on the data D_{H}42 and the data D_{L}42, thereby generating the display data D_{VGA}42. Consequently, the data voltage corresponding to the display data D_{VGA}42 is generated.

Still further, the first 6-bit data D_{H}43 of the display data D_{VGA}43 is supplied from the display controller 38 as the input data, and the bit-wise merge is performed on the data D_{H}43 and the data D_{L}43, thereby generating the display data D_{VGA}43. Consequently, the data voltage corresponding to the display data D_{VGA}42 is generated.

Moreover, the first 6-bit data D_{H}44 of the display data D_{VGA}44 is supplied from the display controller 38 as the input data, and the bit-wise merge is performed on the data D_{H}44 and the data D_{L}44, thereby generating the display data D_{VGA}44. Consequently, the data voltage corresponding to the display data D_{VGA}44 is generated.

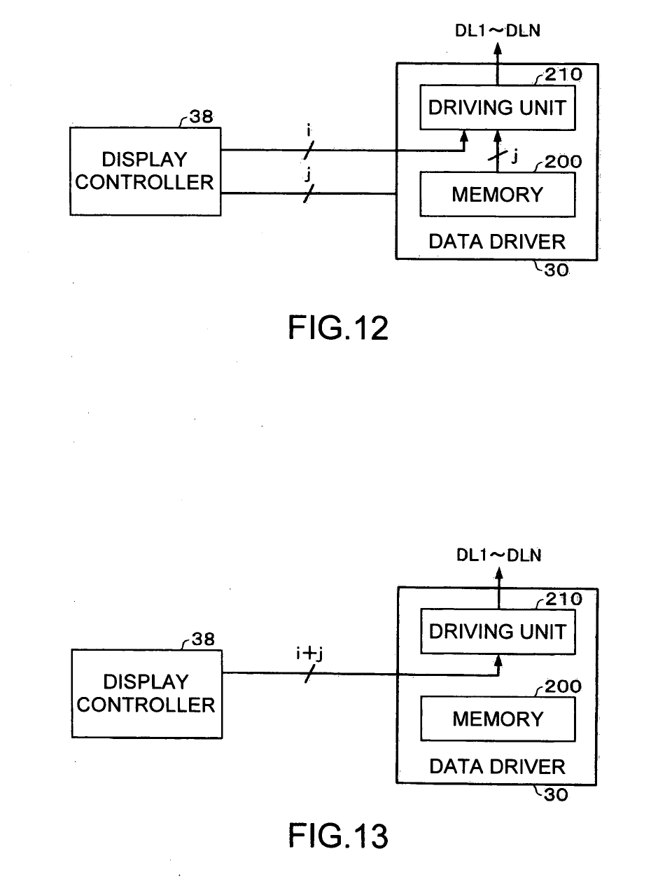

In FIG. 12, an explanatory illustration of a case for displaying a still image with the data driver in the embodiment is shown.

In FIG. 12, the SDEN is configured at the H-level by the enable register 246. In the case of displaying a still image, the first/last 4 bits (where j is 4 in “j bits of data”) is held in advance in the memory 200. Then, the data driver 30 generates the 8-bit display data, whit the display controller 38 supplying the first/last 4 bits of the display data for each dot (where j is 4 in “j bits of data”), and the driving section 210 drives the data line.

This makes it possible to cut down the power consumption due to the data transfer, since the number of bits of the display data, supplied from the display controller 38 required, is i-bit. Moreover, the driving section 210 drives the data lines based on the 8-bit display data; hence it is possible to drive the liquid crystal display panel of sizes not only the QVGA but also the HVGA and VGA, without cutting down the gradation number. Particularly, in the case of still images of natural images, the data change in the first 4 bit of the display data supplied from the display controller 38 is little; thus the frequency of the data change of the 4-bit data supplied from the display controller 38 is smaller, thereby allowing the further cut down of the power consumption.

In FIG. 13, an explanatory illustration of a case for displaying a moving image with the data driver in the embodiment is shown.

In FIG. 13, the SDEN is configured at the L-level by the enable register 246. In the case of displaying a moving image, the retained data held in the memory 200 is ignored, and the data driver 30 receives the 8-bit input data for every dot from the display controller 38, and the input data is made as the one-dot equivalent display data. Further, the driving section 210 drives the data lines based on the display data.

Due to the above, with the same data driver 30 that displays a still image, a moving image display can be performed.

3.2 Specific Example Structure

Hereafter, a detailed example structure of the data driver 30 in FIG. 4 will be described. For the sake of explanation, one pixel (3-dots long) shall have R, G, and B components, and each component shall be represented by 8-bit display data. However, the number of dots composing one pixel and the number of bits per dot shall not limit the configuration. Moreover, in order to simplify the description, the data driver 30 shall drive the 2 pixels (6 dots) aligned in the horizontal scanning direction.

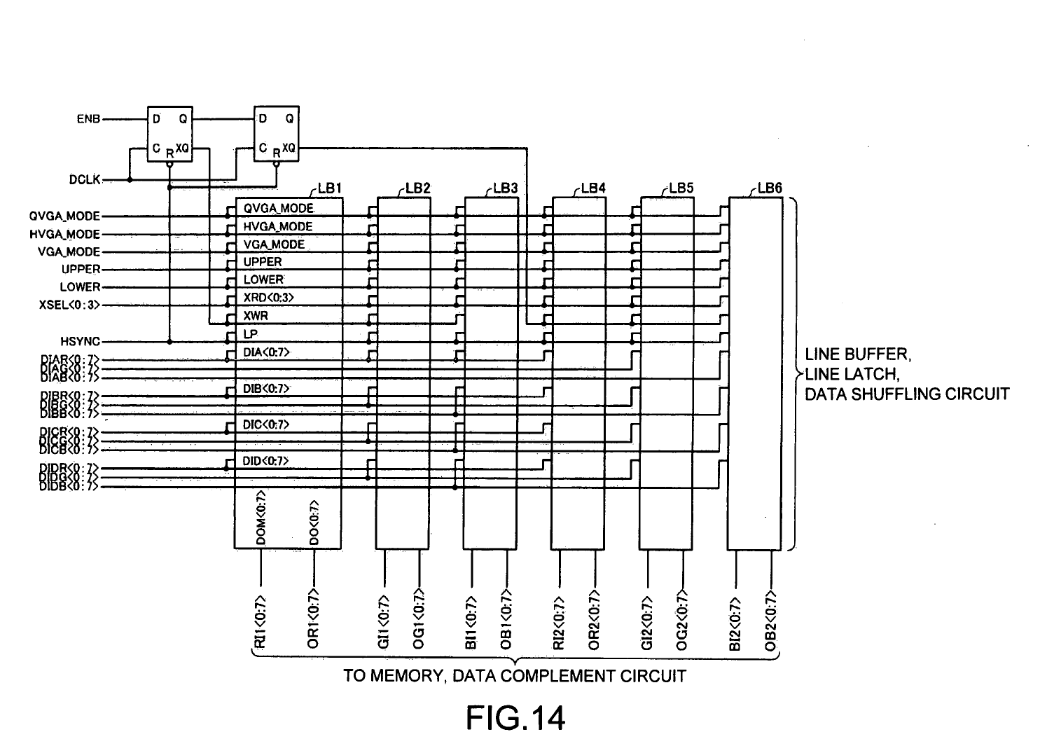

In FIG. 14, a block circuit diagram of an example structure of the line buffer, the line latch, and the data shuffling circuits in FIG. 4, is shown.

In FIG. 14, circuit blocks LB1 through LB6, in which each circuit block performs processing by dot unit, are installed. More specifically, each circuit block in the circuit block LB1 through LB6, has functions of the line buffer, the line latch and the data shuffling circuit toward one-dot equivalent display data.

The data for letting the memory 200 hold the retained data is supplied to: DIAR<0:7>, DIAG<0:7>, DIAB<0:7>, DIBR<0:7>, DIBG<0:7>, DIBB<0:7>, DICR<0:7>, DICG<0:7>, DICB<0:7>, DIDR<0:7>, DIDG<0:7>, and DIDB<0:7>. The data for writing in to the memory 200 from the display controller 38 or from the host, can be input as: DIAR<0:7>, DIAG<0:7>, DIAB<0:7>, DIBR<0:7>, DIBG<0:7>, DIBB<0:7>, DICR<0:7>, DICG<0:7>, DICB<0:7>, DIDR<0:7>, DIDG<0:7>, and DIDB<0:7>, in correspondence to the set value of the panel size configuration register 242.

If the QVGA_MODE is at the H-level, the 8-dot display data for R component is supplied to the DIAR<0:7>, the 8-dot display data for G component is supplied to the DIAG<0:7>, and the 8-dot display data for B component is supplied to the DIRB<0:7>.

If the HVGA_MODE is at the H-level, the 8-dot display data for R component is supplied to the DIAR<0:7> and the DIBR<0:7>, the 8-dot display data for G component is supplied to the DIAG<0:7> and the DIBG<0:7>, and the 8-dot display data for B component is supplied to the DIAB<0:7> and DIBB<0:7>.

If the VGA_MODE is at the H-level, the 8-dot display data for R component is supplied to the DIAR<0:7>, the DIBR<0:7>, the DICR<0:7>, and to the DIDR<0:7>, the 8-dot display data for G component is supplied to the DIAG<0:7>, the DIBG<0:7>, DICG<0:7>, and the DIDG<0:7>, and the 8-dot display data for B component is supplied to the DIAB<0:7>, the DIBB<0:7>, the DICB<0:7>, and DIDB<0:7>.

ENB, the write-in enable of the data, is shifted by the clock signal DCLK, and in synchronization with the shift output, the data is retrieved in the circuit blocks LB1 through LB6, and a shuffling processing so as to write the data in to the memory 200 is conducted, for every 3 dots that compose one pixel. Each circuit block in the circuit blocks LB1 through LB6 has a similar structure.

RI1<0:7>, GI1<0:7>, BI1<0:7>, RI2<0:7>, GI2<0:7>, and BI2<0:7> are output as sets of data so as to be written in to the memory 200. OR1<0:7>, OG1<0:7>, OB1<0:7>, OR2<0:7>, OG2<0:7>, and OB2<0:7> are output as sets of data that bypass the memory 200.

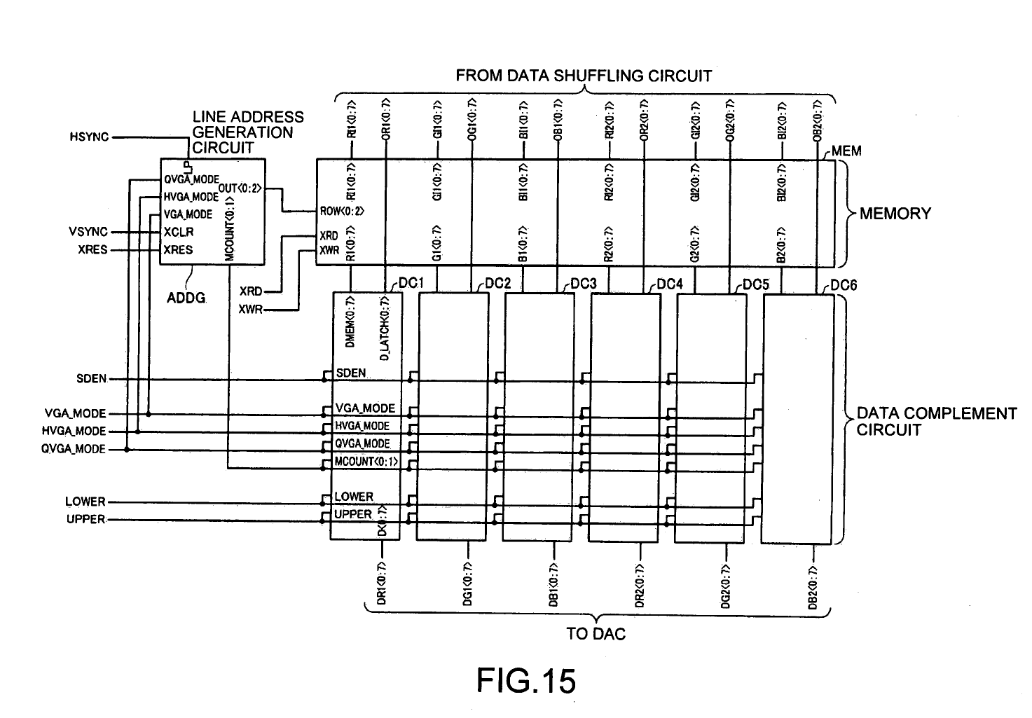

In FIG. 15, a block circuit diagram of an example structure of the memory and the complement circuit in FIG. 4, is shown.

Besides the diagram of the memory and the data complement circuit, a circuit block ADDG of the line address generation circuit 262 is also shown in FIG. 15.

The function of the memory 200 is implemented by a circuit block MEM. The function of the line address generation circuit 262 is implemented by a circuit block ADDG.

In the circuit block MEM, sets of data for RI1<0:7>, GI1<0:7>, BI1<0:7>, RI2<0:7>, GI2<0:7>, and BI2<0:7> are written in to the memory cells of the line addresses specified by the ROW<0:2> from the circuit block ADDG. Similarly, in the circuit block MEM, sets of retained data are read out from the memory cells of the line addresses specified by the ROW<0:2> from the circuit block ADDG, and are output as R1<0:7>, G1<0:7>, B1<0:7>, R2<0:7>, G2<0:7>, and B2<0:7>.

The function of the data complement circuit 270 is implemented by circuit blocks DC1 through DC6. Each circuit block of the circuit blocks DC1 through DC6 performs the bit-wise merge on the input data and the retained data, and generates the display data with bit numbers equivalent to one dot. Each circuit block in the circuit blocks DC1 through DC6 has a similar structure. The circuit blocks DC1 through DC6 output DR1<0:7>, DG1<0:7>, DB1<0:7>, DR2<0:7>, DG2<0:7>, and DB2<0:7> as sets of data after complement.

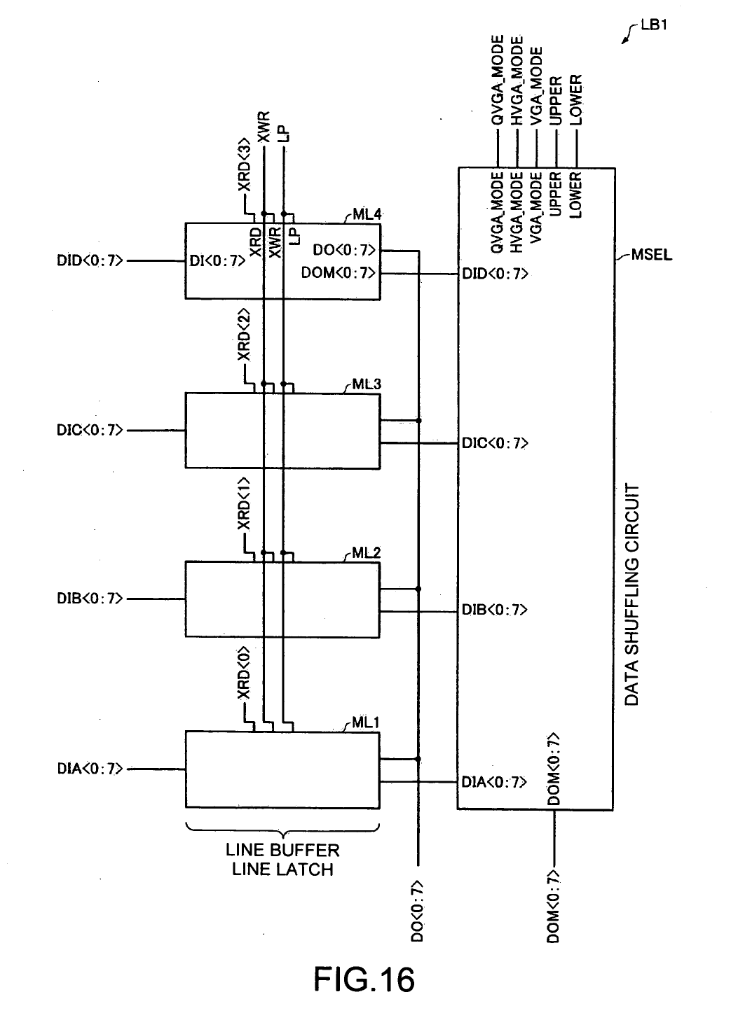

In FIG. 16, a block circuit diagram of an example structure of the circuit block LB1 in FIG. 14 is shown.

The circuit blocks LB2 through LB6 are similar to the circuit block LB1 in FIG. 14.

The functions of the line buffer 220 and the line latch 230 are implemented by circuit blocks ML1 through ML4. Each circuit block in the circuit blocks ML1 through ML4 retrieve 8-bit data based on XWR, and is latched at LP. The data latched in each circuit block of the circuit blocks ML1 through ML4 is output as DOM<0:7> for writing in to the memory 200, and, at the same time, is output as DO<0:7> as the input data that bypasses the memory 200. Each circuit block in the circuit blocks ML1 through M14 has a similar structure.

In FIG. 16, the function of the data shuffling circuit 250 is implemented by a circuit block MSEL. The circuit block MSEL conducts a processing of shuffling DIA<0:7>, DIB<0:7>, DIC<0:7>, and DID<0:7>, in accordance with the set value of the panel size configuration register 242 and the high/low bit configuration register 244.

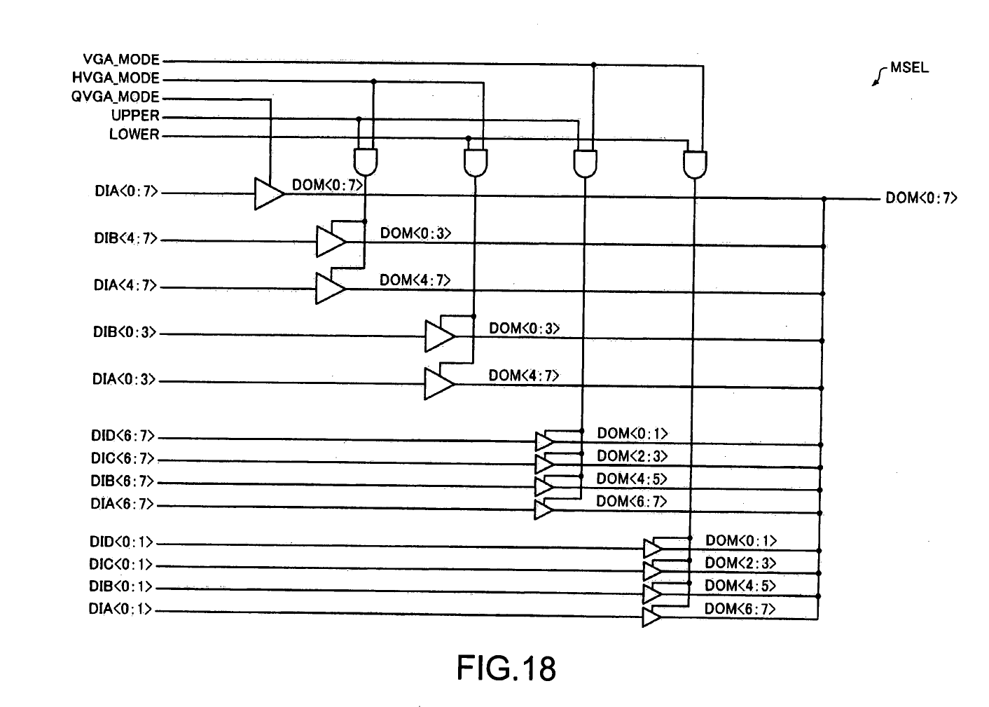

In FIG. 18, a circuit diagram of an example structure of the circuit block MSEL in FIG. 16 is shown.

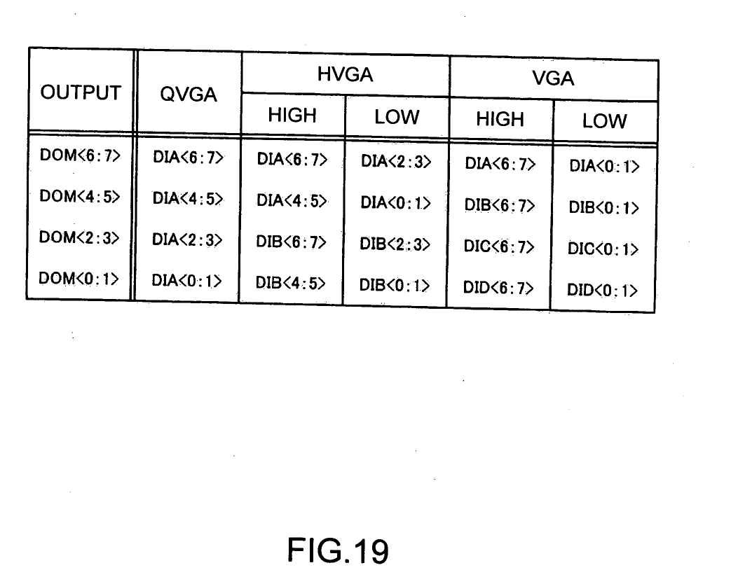

In FIG. 19, an explanatory illustration of an operation example of the circuit block MSEL in FIG. 18 is shown.

As described, the circuit block MSEL outputs the DIA<0:7> as it is as DOM<0:7>, when the QVGA_MODE is at the H-level. Moreover, the circuit block MSEL outputs DIB<4:7> as DOM<0:3> and DIA<4:7> as DOM<4:7>, when the HVGA_MODE as well as the UPPER are at the H-level. Furthermore, the circuit block MSEL outputs DIB<0:3> as DOM<0:3> and DIA<0:3> as DOM<4:7>, when the HVGA_MODE as well as the LOWER are at the H-level.

Further, the circuit block MSEL outputs DID<6:7> as DOM<0:1>, DIC<6:7> as DOM<2:3>, DIB<6:7> as DOM<4:5>, and DIA<6:7> as DOM<6:7>, when the VGA_MODE as well as the UPPER are at the H-level. Still further, the circuit block MSEL outputs DID<0:1> as DOM<0:1>, DIC<0:1> as DOM<2:3>, DIB<0:1> as DOM<4:5>, and DIA<0:1> as DOM<6:7>, when the VGA_MODE as well as the LOWER are at the H-level.

In other words, the circuit block MSEL conducts the shuffling processing so as to make the memory 200 hold data as the retained data.

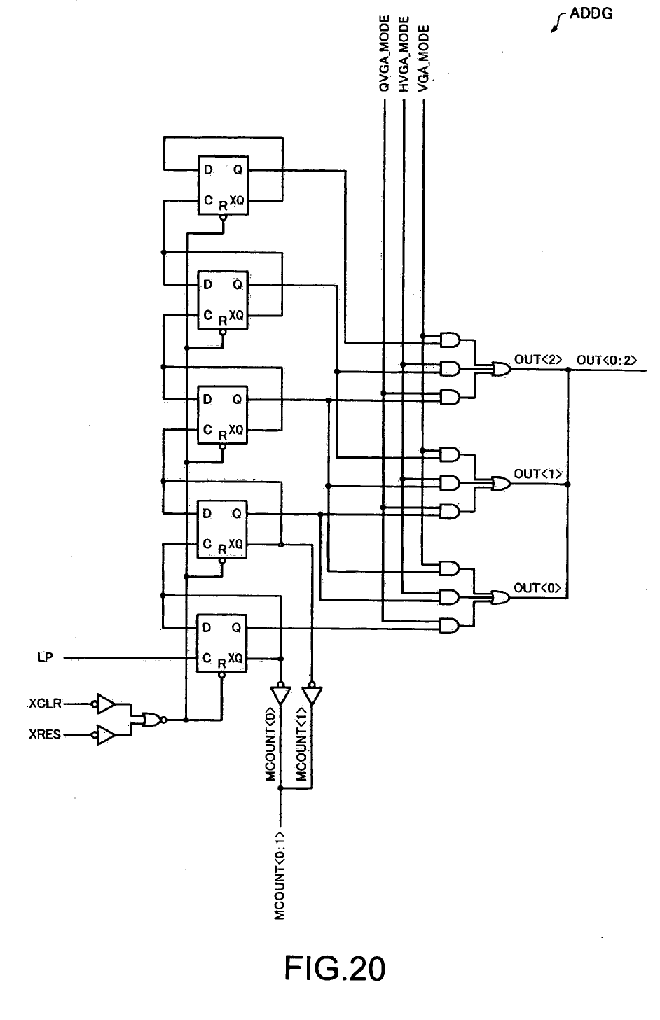

In FIG. 20, a circuit diagram of an example structure of the circuit block ADDG in FIG. 15 is shown.

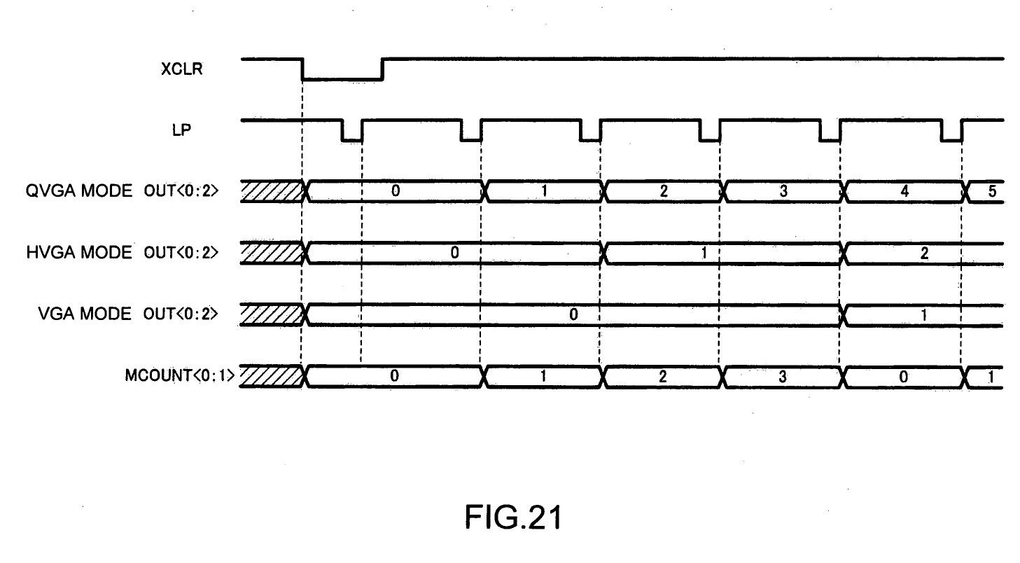

In FIG. 21, a timing chart of the operation example of the circuit block ADDG in FIG. 20 is shown.

The circuit shown in FIG. 20 implements the function of the line address generation circuit 262. The circuit block ADDG outputs OUT<0:2>, which indicates the line address that is refreshed every one, two, or four horizontal scanning periods, in accordance with the set value of the panel size configuration register 242.

More specifically, the circuit block ADDG has a ripple counter that counts up in synchronization with the LP (horizontal synchronization signal). The circuit block ADDG selects the output of the flip-flop that structures the ripple counter, in accordance with the panel size configuration register 242.

In other words, as shown in FIG. 21, the circuit block ADDG outputs: OUT<0:2> that is refreshed every one horizontal scanning period if the QVGA_MODE is at the H-level; OUT<0:2> that is refreshed every two horizontal scanning periods if the HVGA_MODE is at the H-level; and OUT<0:2> that is refreshed every four horizontal scanning period if the VGA_MODE is at the H-level.

Moreover, the circuit block ADDG outputs 2-bit count value, which is counted up in synchronization with the LP, as MCOUNT<0:1>. The MCOUNT<0:1> is used in a circuit block that implements the function of the data complement circuit.

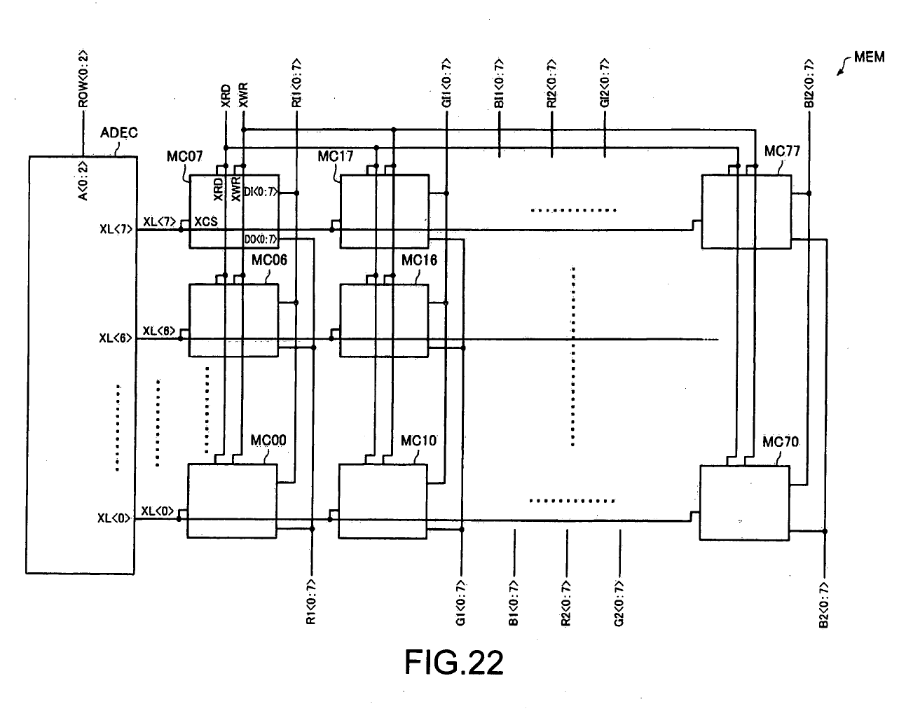

In FIG. 22, a block circuit diagram of an example structure of the circuit block MEM in FIG. 15 is shown.

The circuit block MEM includes a circuit block ADEC that conducts an address decoding in order to select memory cells, and a plurality of memory cells MC00 through MC77, each of which holds 8-bit data. Since each memory cell is structured with, for instance a common flip-flop, the detailed description of the structure of each memory cell is omitted.

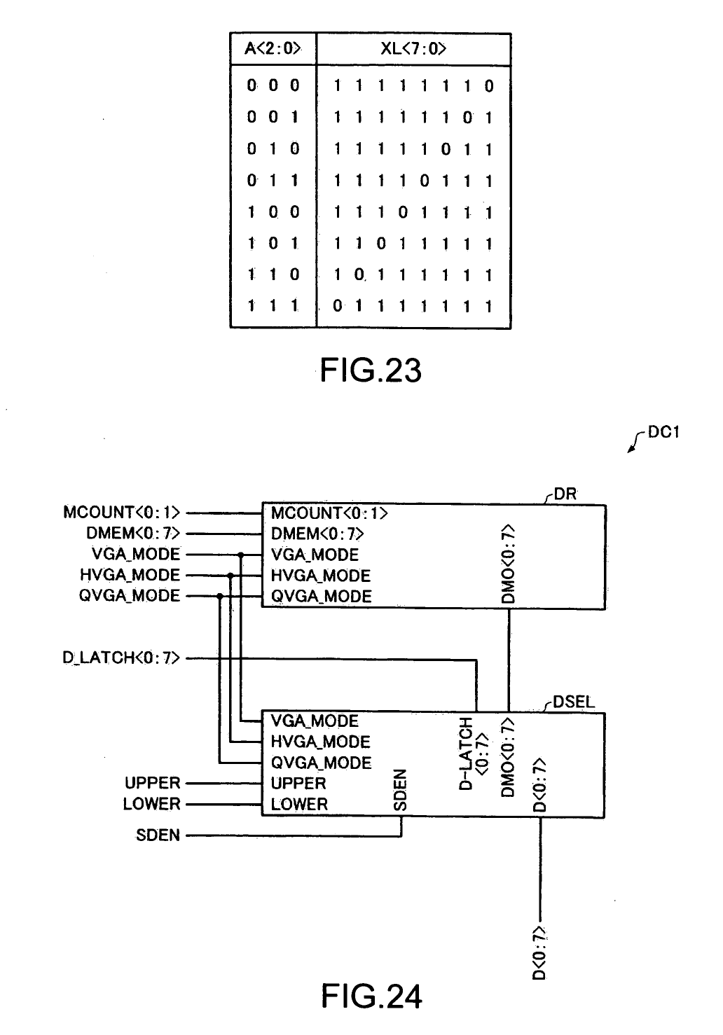

In FIG. 23, an explanatory illustration of an operation example of the circuit block ADEC in FIG. 22 is shown.

The ROW<0:2> from the circuit block ADDG is input to the circuit block ADEC. As shown in FIG. 23, the circuit block ADEC selects any one item in data table XL<0:7>. In FIG. 23, any one of the data set in the data table XL<0:7> becomes L-level, in accordance with the ROW<0:2>.

In FIG. 22, XL<0> is connected to the memory cells MC00, MC10, . . . MC70. XL<1> is connected to the memory cells MC01, MC11, . . . MC71. Similarly, XL<6> is connected to the memory cells MC06, MC16, . . . . MC76. Likewise, XL<7> is connected to the memory cells MC07, MC17, . . . MC77.

The data set written in to the memory cells MC00 through MC07 is RI1<0:7>, and the data set read out from the memory cells MC00 through MC07 is R1<0:7>. The data set written in to the memory cells MC10 through MC17 is GI1<0:7>, and the data set read out from the memory cells MC10 through MC17 is G1<0:7>.

In such circuit block MEM, 8×8 bits of data is written in as the retained data to the memory cells of the line address specified by XL<0:7>, in synchronization with the XWR. On the other hand, 8×8 bits of data is read out as the retained data from the memory cells of the line address specified by XL<0:7>, in synchronization with the XRD

In FIG. 24, a block circuit diagram of an example structure of the circuit block DC1 in FIG. 15 is shown.

The circuit block DC1 includes a circuit block DR and a circuit block DSEL. In the circuit block DR, in order to perform the bit-wise merge on the input data and the retained data read out from the circuit block MEM, the processing of shifting the bit location of the retained data is performed. In the circuit block DSEL, the bit-wise merge is performed on the retained data DMO<0:7> and the input data D_LATCH<0:7> that have bypassed the circuit block MEM etc., thereby outputting the result as D<0:7>.

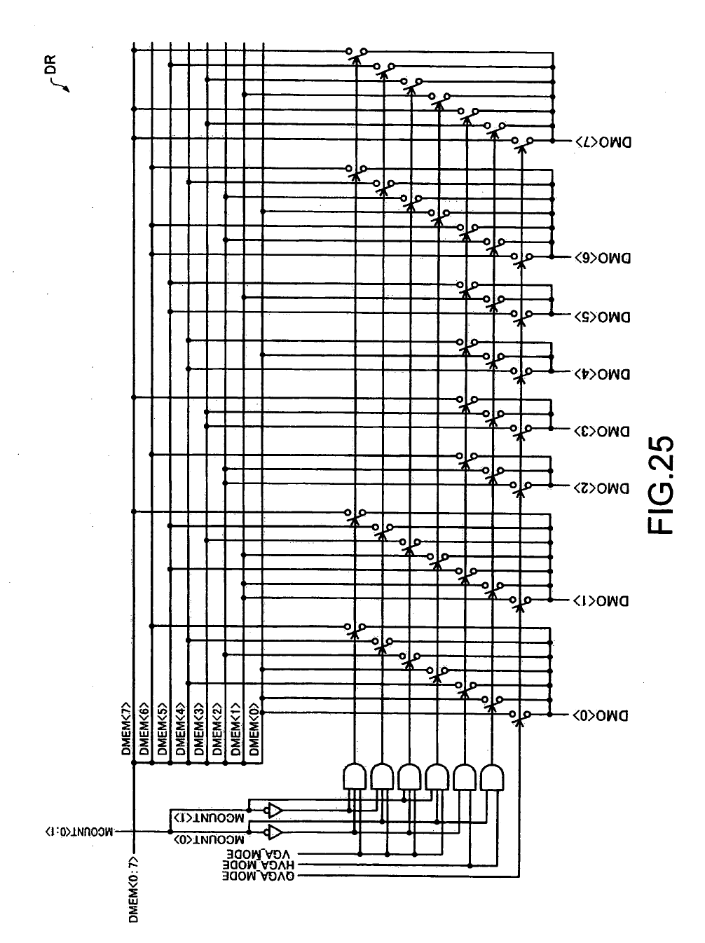

In FIG. 25, a circuit diagram of an example structure of the circuit block DR in FIG. 24 is shown.

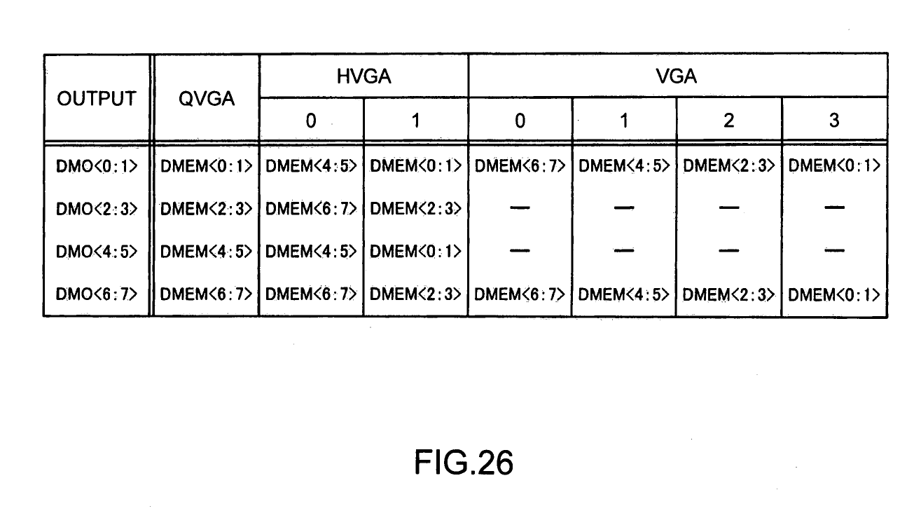

In FIG. 26, a timing chart of the operation example of the circuit block DR in FIG. 25 is shown.

As shown in FIG. 26, since DMEM<0:7> read out from the circuit block MEM is used as it is in the circuit block DR if the QVGA_MODE is at the H-level, the DMEM<0:7> is output as it is as the DMO<0:7>.

Moreover, if the HVGA_MODE is at the H-level, then the circuit block DR outputs either DMEM<4:7> or DMEM<0:3>, in accordance with the value of MCOUNT<0>. That is to say, if the MCOUNT<0> is 0, then data set DMEM<4:7> is output to DMO<0:3> and to DMO<4:7>. If the MCOUNT<1> is 1, DMEM<0:3> is output to DMO<0:3> and DMO<4:7>. If the HVGA_MODE is at the H-level, the DMEM<0:7> read out from the circuit block MEM is 2-dot equivalent retained data; hence, in accordance with the value of the MCOUNT<0>, the first/last 4 bits is output as DMO<0:7>.

Furthermore, if the VGA_MODE is at the H-level, then the circuit block DR outputs any one of DMEM<0:1>, DMEM<2:3>, DMEM<4:5> or DMEM<6:7>, in accordance with the value of MCOUNT<0:1>. That is to say, if the MCOUNT<0:1> is 0, then DMEM<6:7> is output to DMO<0:1> and to DMO<6:7>. If the MCOUNT<0:1> is 1, then DMEM<4:5> is output to DMO<0:1> and to DMO<6:7>. If the MCOUNT<0:1> is 2, then DMEM<2:3> is output to DMO<0:1> and to DMEM<6:7>. If the MCOUNT<0:1> is 3, then DMEM<0:1> is output to DMO<0:1> and to DMEM<6:7>. If the HVGA_MODE is at the H-level, the DMEM<0:7> read out from the circuit block MEM is 4-dot equivalent retained data; hence, in accordance with the value of the MCOUNT<0:1>, each 2 bits are output as DOM<0:7>.

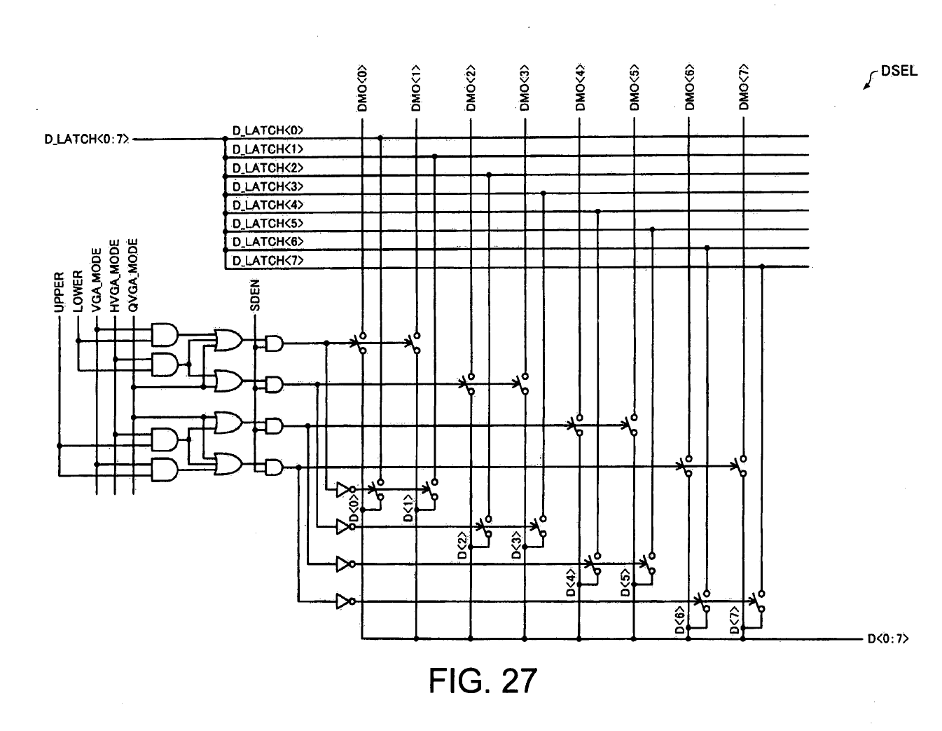

In FIG. 27, a circuit diagram of an example structure of the circuit block DSEL in FIG. 24 is shown.

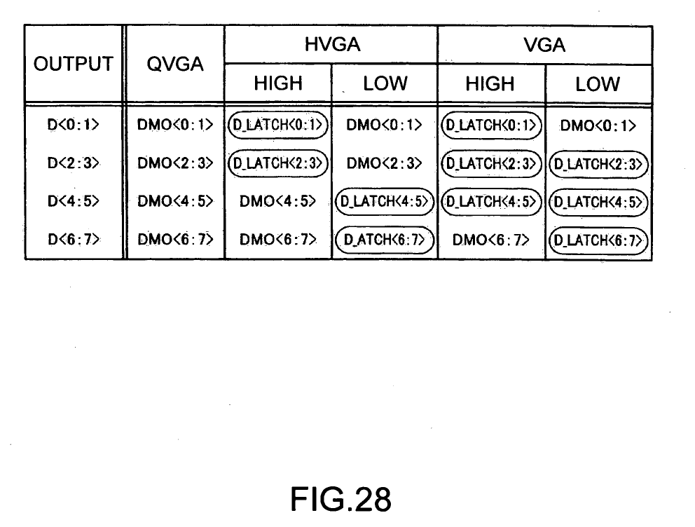

In FIG. 28, a timing chart of the operation example of the circuit block DSEL in FIG. 27 is shown.

If the SDEN is set at the H-level by the enable register 246, then the circuit block DSEL performs the bit-wise merge processing on the input data and the retained data.

If the SDEN is set at the L-level by the enable register 246, then the circuit block DSEL does not perform the bit-wise merge processing on the input data and the retained data. Therefore, the input data retrieved into the line buffer 220 and the line latch 230, is used as it is as the display data. Therefore, it is possible to make the circuit block DSEL to conduct a moving image display, where the data of the moving image does not require to be held in the memory 200.

On the other hand, in the case of displaying a still image, the circuit block DSEL operates as shown in FIG. 28.

That is to say, the circuit block DR outputs the DMO<0:7> as it is as D<0:7>, when the QVGA_MODE is at the H-level. This is because there is no need to perform the bit-wise merge on the input data and the retained data, if the QVGA_MODE is at the H-level.

If the HVGA_MODE as well as the UPPER are at the H-level, the D_LATCH<0:3>, which is a data set for the last 4 bits of the input data, is output as D<0:3>, and the DMO<4:7>, which is the first 4 bits of the retained data, is output as D<4:7>. Moreover, if the LOWER is at the H-level, the D_LATCH<0:3>, which is a data set for the last 4 bits of the input data, is output as the D<0:3>, and the DMO<4:7>, which is the first 4 bits of the retained data, is output as the D<4:7>.

If the VGA_MODE as well as the UPPER are at the H-level, D_LATCH<0:5>, which is a data set for the last 6 bits of the input data, is output as D<0:5>, and the DMO<6:7>, which is the first 2 bits of the retained data, is output as D<6:7>. Moreover, if the LOWER is at the H-level, the DMO<0:1>, which is a data set for the last 2 bits of the retained data, is output as D<0:1>, and D_LATCH<2:7>, which is the first 6 bits of the input data, is output as D<2:7>.

Thereafter, the D<0:7>, which the circuit block DSEL outputs, is supplied to the DAC 290 as the one-dot equivalent display data.

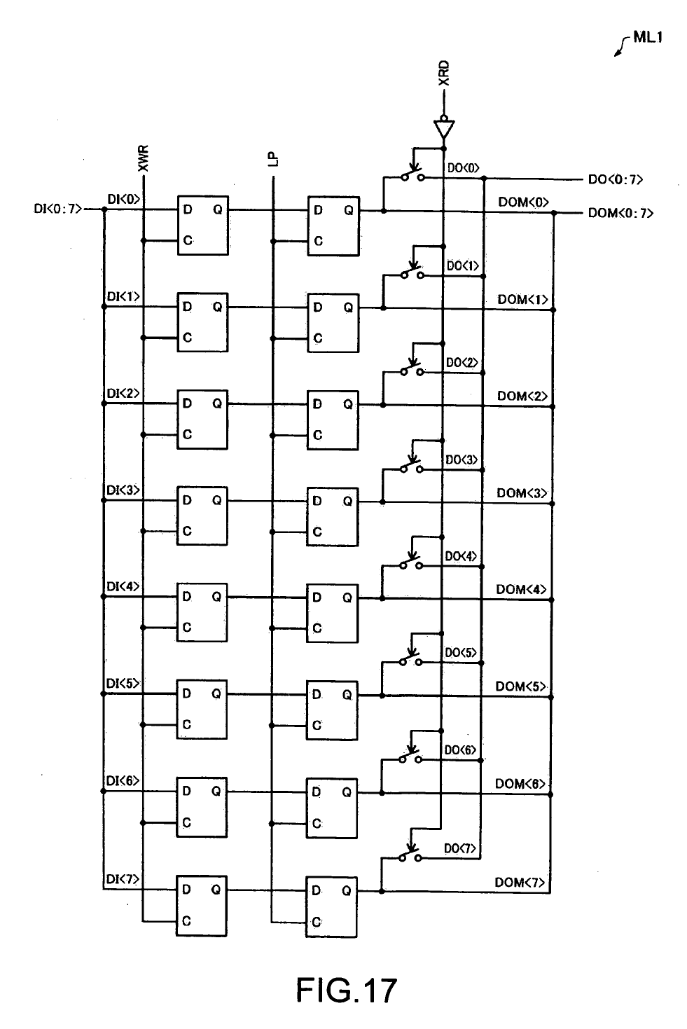

As described above, the operations described in FIGS. 7 through 11 can be implemented with the configuration described in FIGS. 14 through 28.

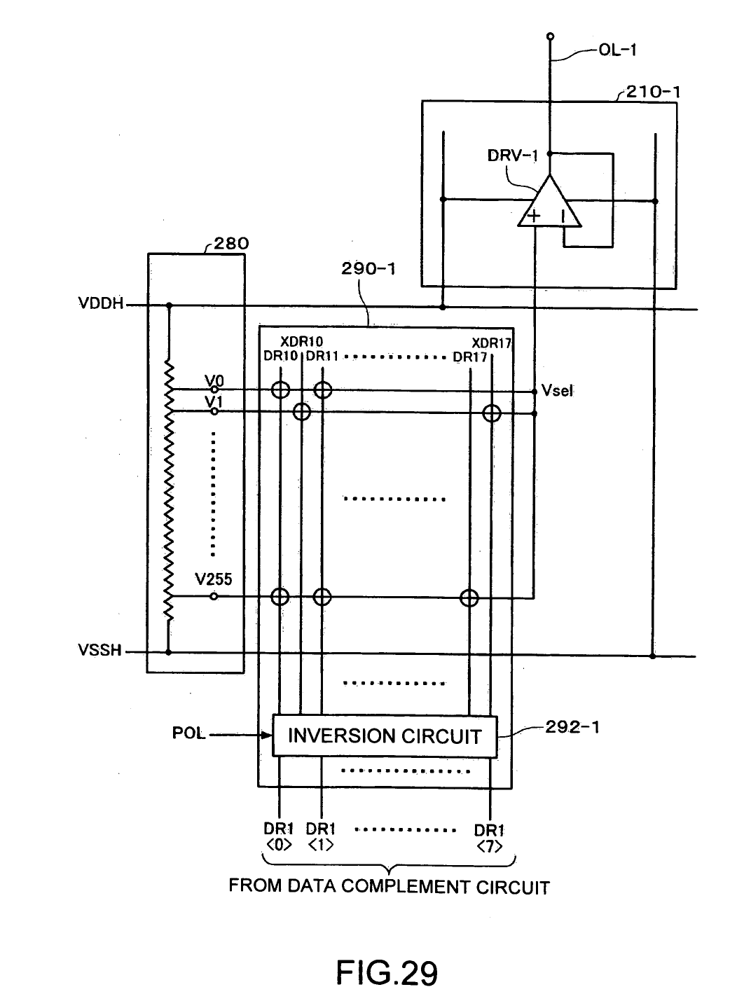

In FIG. 29, is a circuit diagram of an example structure of the reference voltage generation circuit, the DAC, and the driving section in FIG. 4 is shown.

As shown in FIG. 29, only the configuration of an output line OL-1 in the driving section 210, the output line being connected to the data line DL1, is shown. However, other output lines are also similar.

In the reference voltage generation circuit 280, a resistor circuit is connected between the source voltage VDDH at a high potential and the source voltage VSSH at a low potential. Moreover, the reference voltage generation circuit 280 generates the plurality of divided voltages as the reference voltages V0 through V255, where the divided voltages are a result of the voltage level difference between the source voltage VDDH at a high potential and the source voltage VSSH at a low potential, divided into by the resistor circuit. In the case of the polarity inversion drive, the voltages with positive and negative polarity do not actually become symmetric; hence the reference voltage for positive polarity and the reference voltage for negative polarity are generated. In FIG. 29, one of the two is shown.

A DAC290-1 can be implemented by ROM (Read Only Memory) decoder circuit. DAC290-1 selects any one of the reference voltages V0 through V255 based on the 8-bit display data, and outputs it to a driving section 210-1 as selected voltage Vsel.

The DAC290-1 includes an inversion circuit 292-1. The inversion circuit 292-1 inverts the display data based on the polarity inversion signal POL. Then, sets of 8-bit display data D10 through D17 and 8-bit inverted display data XDR10 through XDR17 are input into the DAC290-1. The set of inverted display data XDR10 through XDR17 are a result of the display data DR10 through DR17 being inverted. Thereafter, in the DAC290-1, any one of the reference voltages V0 through V255 with many values, the reference voltages being generated by the reference voltage generation circuit 280, is selected based on the display data.

For instance, if the polarity inversion signal POL is at the H-level, then the reference voltage V2 is selected corresponding to the set of 8-bit display data DR10 through DR17 “00000010”, which represents 2. Moreover, if the polarity inversion signal POL is, for instance, at the L-level, the reference voltage is selected by using the set of inverted display data XDR10 through XDR17, into which the set of display data DR10 through DR17 is inverted. In other words, the set of inverted display data XDR10 through XDR17 is “11111101”, representing 253; thereby the reference voltage V253 is selected.

This way, the selected voltage Vsel selected by the DAC290-1 is supplied to the driving section 210-1.

The driving section 210-1 has an operational amplifier DRV-1, in which the voltage follower is connected. The operational amplifier DRV-1 drives the output line OL-1 based on the selected voltage Vsel. As mentioned above, the power supply circuit 100 changes the voltage of the counter electrode in synchronization with the polarity inversion signal POL. Consequently, the driving section drives the data line (output line) with the polarity of the voltage applied to the liquid crystal inverted.

4. Electronic Instrument

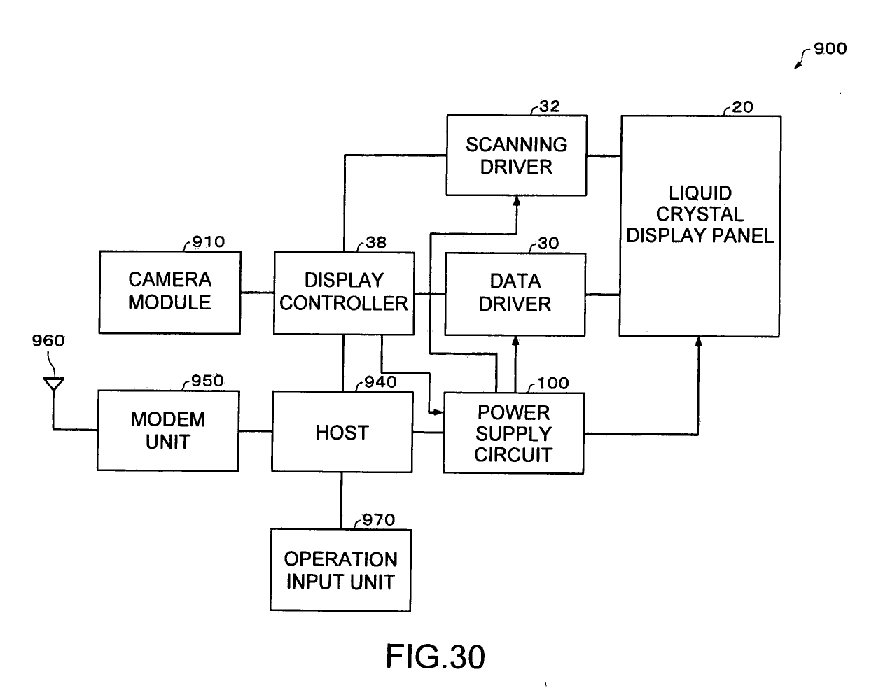

In FIG. 30, a block diagram of the example structure of an electronic instrument in the embodiment is shown. Here, a mobile phone is shown in the block diagram as an example of the electronic instrument. The same signs and numerals are used for the same parts as in FIGS. 1 and 2, and their descriptions are omitted appropriately in FIG. 30.

A mobile phone 900 includes a camera module 910. The camera module 910 includes a CCD camera, and supplies the data of the image photographed by the CCD camera, to the display controller 38 in a YUV format.

The mobile phone 900 includes the liquid crystal display panel 20. The liquid crystal display panel 20 is driven by the data driver 30 and the scanning driver 32. The liquid crystal display panel 20 includes the plurality of data lines, scanning lines, and pixels.

The display controller 38 is connected to the data driver 30 and to the scanning driver 32, and supplies the display data in RGB format to the data driver 30.

The power circuit 100 is connected to the data driver 30 and to the scanning driver 32, and supplies the source voltage to each of the drivers so as to drive them. Moreover, the counter electrode voltage Vcom is supplied to the counter electrode of the liquid crystal display panel 20.

The host 940 is connected to the display controller 38. The host 940 controls the display controller 38. Further, the host 940 allows a demodulation of the display data received through an antenna 960 in a modem part 950, and then allows a supply of the data to the display controller 38. Based on this display data, the display controller 38 displays an image in the liquid crystal display panel 20, with the data driver 30 and the scanning driver 32.

The host 940 can modulate the display data generated by the camera module 910 at the modem part 950, and can subsequently command the transmission of the data to another communication device through the antenna 960.

The host 940 conducts the send/receive processing of the display data, the imaging with the camera module 910, and the display processing of the liquid crystal display panel 20, based on the operational information from an operation input unit 970.

The present invention shall not be limited to the embodiments mentioned above, and within the main scope of the present invention, it is possible to implement the present invention with other kinds of modifications. For example, the invention can be applied, not only to the above-mentioned liquid crystal display panel, but also to the driving of an electro-luminescence or plasma display device.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. A data driver which drives each data line of a plurality of data lines of an electro-optic device based on display data of (i+j) bits (i and j are natural numbers), the data driver comprising:
a memory which previously holds data of j-bit per dot among the display data as retained data; and
a driving section which drives the data line based on the display data,
wherein the driving section drives the data line based on the display data of (i+j) bits, the display data of (i+j) bits being generated by input data of i bits per dot supplied to the data driver, and the retained data read out from the memory.

2. The data driver according to claim 1, further comprising:
a retained data bit number setting register in which a bit number of the retained data is specified,
wherein the data driver generates the display data of (i+j) bits per dot by performing a bit-wise merge on the input data and the retained data, in accordance with a set value of the retained data bit number setting register.

3. The data driver as defined in claim 2, further comprising:
a line address generation circuit which generates a line address used to read out the retained data from the memory, while refreshing the line address in a cycle of at least two horizontal scanning periods,
wherein the retained data for at least 2 dots is read out from the memory based on the line address; and
wherein the data driver generates the display data of (i+j) bits by performing a bit-wise merge on the input data and a part of the retained data for at least 2 dots, in accordance with a set value of the retained data bit number setting register.

4. The data driver as defined in claim 1, wherein:
the retained data is low order j-bit data of the display data of (i+j) bits, including the least significant bit; and
the input data is high order i-bit data of the display data of (i+j) bits, including the most significant bit.

5. The data driver as defined in claim 1, wherein:
the retained data is high order j-bit data of the display data of (i+j) bits, including the most significant bit; and
the input data is low order i-bit data of the display data of (i+j) bits, including the least significant bit.

6. The data driver as defined in claim 1, wherein:
when a still image is displayed, the driving section drives the data line based on the display data generated by the input data and the retained data; and
when a moving image is displayed, the driving section receives an input data of (i+j) bits as the display data, independently from the retained data, and drives the data line based on the display data.

7. The data driver as defined in claim 1, further comprising:
a reference voltage generation circuit that generates 2^{(i+j)} types of reference voltages; and
a voltage selection circuit which selects one reference voltage as a data voltage from the 2^{(i+j)} types of reference voltages, based on the display data of (i+j) bits generated by the input data and the retained data,
wherein the driving section drives the data line based on the data voltage.

8. An electro-optic device comprising:
a plurality of scanning lines;
a plurality of data lines;
a pixel electrode determined by one of the scanning lines and one of the data lines;
a scanning driver which scans the scanning lines; and
the data driver as defined in claim 1 which drives the each data line of the plurality of data lines.

9. An electro-optic device comprising:
a plurality of scanning lines;
a plurality of data lines;
a pixel electrode determined by one of the scanning lines and one of the data lines;
a scanning driver which scans the scanning lines;
the data driver as defined in claim 1 which drives the each data line of the plurality of data lines; and
a processing section which supplies display data to the data driver,
wherein the processing section sets j bits of the display data of (i+j) bits per dot to the memory of the data driver before supplying i-bit data of the display data of (i+j) bits to the data driver.

10. An electronic instrument comprising the data driver as defined in claim 1.

11. An electronic instrument comprising the electro-optic device as defined in claim 8.

12. A driving method of driving each data line of a plurality of data lines of an electro-optic device based on display data of (i+j) bits (i and j are natural numbers), the driving method comprising:
previously setting data of j-bit per dot among the display data as retained data in a memory;
receiving input data of i bits per dot;
generating the display data of (i+j) bits by the input data and the retained data; and
driving one of the data lines based on the display data.

13. The driving method as defined in claim 12, further comprising:
reading out the retained data for at least 2 dots from the memory, in a cycle of at least two horizontal scanning periods; and
generating the display data of (i+j) bits per dot by performing a bit-wise merge on the input data and a part of the retained data for at least 2 dots.

14. The driving method as defined in claim 12, wherein:
the retained data is low order j-bit data of the display data of (i+j) bits, including the least significant bit; and
the input data is high order i-bit data of the display data of (i+j) bits, including the most significant bit.

15. The driving method as defined in claim 12, wherein:
the retained data is high order j-bit data of the display data of (i+j) bits, including the most significant bit; and
the input data is low order i-bit data of the display data of (i+j) bits, including the least significant bit.

16. The driving method as defined in claim 12, wherein:
when a still image is displayed, the data line is driven based on the display data generated by the input data and the retained data; and
when a moving image is displayed, an input data of (i+j) bits is received as the display data, independently from the retained data, and the data line is driven based on the display data.
